(19) United States
(12) Patent Application Publication
(10) Pub. No.: US 2025/0239244 A1
(43) Pub. Date: Jul. 24, 2025

(54) Method and Apparatus for Position Sensing of a Musician Hands

(71) Applicant: Benjamin Thomas Lewry, Kittery, ME (US)

(72) Inventor: Benjamin Thomas Lewry, Kittery, ME (US)

(21) Appl. No.: 19/035,736

(22) Filed: Jan. 23, 2025

Related U.S. Application Data
(60) Provisional application No. 63/624,175, filed on Jan. 23, 2024.

(51) Int. Cl. G10H 1/055; G10H 1/32; G10H 3/10; G10H 3/18

(52) U.S. Cl. CPC G10H 1/0551; G10H 1/32; G10H 3/10; G10H 3/181; G10H 3/188; G10H 2210/331

(57) ABSTRACT

A device includes a sensor circuit configured for installation in a stringed instrument such that the sensor circuit is electrically distinct from a pickup circuit of the stringed instrument, the pickup circuit including a pickup disposed proximate a string of the stringed instrument and configured to produce an audio signal of the stringed instrument in response to a movement of the string, and the string, the sensor circuit including a capacitive sensor and a sensor processing circuit in electronic communication with the capacitive sensor configured to produce a data signal based on a state of the capacitive sensor.

### CROSS REFERENCE TO RELATED APPLICATIONS

This application claims priority under 35 USC 119 from US Provisional Application Ser. No. 63/624, 175 filed on Jan. 23, 2024 and titled METHOD AND APPARATUS FOR POSITION SENSING OF A MUSICIAN HANDS by Benjamin Thomas Lewry, the entire disclosure of which is incorporated herein by reference.

### FIELD OF THE INVENTION

The present disclosure relates to musical instruments and more specifically, related to detecting hand positions on a musical instrument.

### BACKGROUND

Musicians who play instruments often use pickups, amplifiers, signal processors, and other electronics to perform their instruments. These electronic systems often become an integral part of the instrument's sound. Musicians may control the volume, pitch, and tone of an instrument as part of a performance. Controls may include knobs, sliders, vibrato systems, and buttons that can be operated to change volume, tone, and other parameters that make up the instrument's sound. However, use of these controls often requires the musician to remove their hands from a normal playing position relative to the instrument. For example, a guitarist may need to abandon a string plucking technique with one hand in order to rotate a knob or press a button with that same hand. A keyboard or piano player may need to lift their hand from the keys in order to activate a pitch modulator or volume control. Musicians will often use a foot operated control instead, however these controls typically require the musician to stand or sit near the control.

There exists a need for the traditional controls to have expanded functionality, ergonomics, and greater expressive potential. Expanded functionality can make using the controls easier, more ergonomic, and provide greater musical expression.

### SUMMARY

In some implementations, a stringed instrument includes a pickup circuit including a pickup disposed proximate a string of the stringed instrument and configured to produce an audio signal of the stringed instrument in response to a movement of the string. The stringed instrument may include a sensor circuit electrically distinct from the pickup circuit and the string and including a cantilevered musical expression lever having an insulated section and a conductive section composing a capacitive touch sensor and a sensor processing circuit in electronic communication with the capacitive touch sensor configured to produce a data signal based on a state of the capacitive touch sensor.

In some implementations, a stringed instrument includes a pickup circuit including a pickup disposed proximate a string of the stringed instrument and configured to produce an audio signal of the stringed instrument in response to a movement of the string. The stringed instrument may include a sensor circuit electrically distinct from the pickup circuit and the string and including a capacitive sensor and a sensor processing circuit in electronic communication with the capacitive sensor configured to produce a data signal based on a state of the capacitive sensor.

In some implementations, a method includes providing a stringed instrument. The method may include a pickup circuit including a pickup disposed proximate a string of the stringed instrument and configured to produce an audio signal of the stringed instrument in response to a movement of the string. The method may include a sensor circuit electrically distinct from the pickup circuit and the string and including a capacitive sensor and a sensor processing circuit in electronic communication with the capacitive sensor configured to produce a data signal based on a state of the capacitive sensor. The method may include producing, by the pickup circuit, the audio signal to an audio output of the stringed instrument. The method may provide receiving, at the sensor processing circuit, the state of the capacitive sensor; The method may provide producing, by the sensor processing circuit, the data signal to a data output of the stringed instrument based on the state of the capacitive sensor.

In some implementations, a device includes a sensor circuit configured for installation in a stringed instrument such that the sensor circuit is electrically distinct from a pickup circuit of the stringed instrument, the pickup circuit including a pickup disposed proximate a string of the stringed instrument and configured to produce an audio signal of the stringed instrument in response to a movement of the string, and the string, the sensor circuit including a capacitive sensor and a sensor processing circuit in electronic communication with the capacitive sensor configured to produce a data signal based on a state of the capacitive sensor.

### BRIEF DESCRIPTION OF THE DRAWINGS

In order to more fully understand the invention, reference is made to the accompanying drawings or figures. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1A shows a musical instrument with a touch and proximity sensitive sensor.

FIG. 1B shows a musical instrument with a touch sensitive sensor and a pickup selector.

FIG. 1C shows a musical instrument with a touch sensitive sensor and an instrument control sensor.

FIG. 1D shows musical instrument 100D with multiple touch or proximity sensitive sensor surfaces and multiple instrument pickups.

FIG. 1E shows sensor assembly 185.

FIG. 1F shows a diagram of capacitive fields between sensor surfaces and instrument parts.

FIG. 2A shows a musical instrument 100 with an electronic vibrato assembly 200.

FIG. 2B shows a side view of a touch sensitive electronic vibrato assembly which may be part of a touch or proximity sensor assembly.

FIG. 2C shows a function block diagram of an electronic vibrato assembly serving as a sensor surface which is a part of a sensor assembly.

FIG. 2D shows a whammy bar assembly which may be a part of an electronic or mechanical vibrato system.

FIG. 2E shows a touch sensitive whammy bar assembly.

FIG. 2F shows a touch sensitive mechanical vibrato system from a side perspective.

FIG. 2G shows a touch sensitive mechanical vibrato system from a rear perspective.

FIG. 3A shows a musical instrument with a touch sensitive knob assembly.

FIG. 3B shows an exploded view of a knob assembly.

FIG. 3C shows an assembled view of a knob assembly.

FIG. 4A shows a touch and proximity sensitive button assembly attached to a musical instrument.

FIG. 4B shows a touch and proximity sensitive button.

FIG. 4C shows an exploded view of a touch and proximity sensitive button.

FIG. 5A shows a truss rod on a musical instrument.

FIG. 5B shows a bisected view of a musical instrument neck.

FIG. 5C shows another bisected view of a musical instrument neck.

FIG. 6A shows a sensor array of a musical instrument

FIG. 6B shows a function block diagram of a multiplex IC connected to a controller.

FIG. 6C shows another sensor array of a musical instrument.

FIG. 7A shows a musical instrument with a pickup position sensor for determining a location of a hand of a musician along a string path.

FIG. 7B shows another musical instrument with a pickup position sensor for determining a location of a hand of a musician along a string path.

FIG. 7C shows a pickup position sensor.

FIG. 7D shows another pickup position sensor.

FIG. 7E shows an optical hand position sensor system for detecting a musician hand position.

FIG. 7F shows an optical hand position sensor system for detecting a musician hand position.

FIG. 7G shows a pickguard with pickups and pickup sensors.

FIG. 7H shows another pickguard with pickups and pickup sensors.

FIG. 8A shows a touch sensitive pickup selection system.

FIG. 8B shows a side view of a touch sensitive pickup selection system.

FIG. 9 shows a concealed sensor assembly

FIG. 10A shows a self capacitance sensor circuit of a musical instrument.

FIG. 10B shows a controller with a sensor pin connected to a sensor circuit.

FIG. 11 shows a resonant circuit 1100 as a type of sensor circuit.

FIG. 12A shows a functional block diagram of a capacitive coupling signal sensor.

FIG. 13 shows an oscillator circuit.

FIG. 14A shows a flowchart of controller operation.

FIG. 14B shows a flowchart of sensor calibration.

FIG. 14C shows a flowchart of sensor run loop

FIG. 14D shows a flowchart of self capacitance sensor loop.

FIG. 14E shows a flowchart of a resonant sensor loop.

FIG. 15A shows an audio processor 140.

### DETAILED DESCRIPTION

The present disclosure may provide a musician with additional controls of a musical instrument. In an example, a guitar may have a touch sensitive component, such as a touch sensitive vibrato arm. A vibrato arm may also be referred to as a whammy bar and/or a cantilevered musical expression lever. The vibrato arm may be partially coated with an insulative material. An insulated section of the vibrato arm may allow the vibrato arm to be used as a traditional vibrato arm while the exposed (i.e., without insulative material) part of the vibrato arm may add additional touch sensitive functionality. An example of the additional functionality may be to add an additional effect when an exposed part of the vibrato arm is touched by a musician. Additionally, in some examples, the vibrato arm insulative material on the vibrato arm may be optional. As such, a part of the vibrator arm exposed to a musician may be touch sensitive.

In another example, a musician may use a touch or proximity sensitive component on the instrument to select a pickup from among two or more pickups on the instrument. For example, a musician may change from one pickup to another by touching a touch sensitive screw on a guitar. In another example, a musician may change from one pickup to another by placing a hand in closer proximity to a desired pickup.

A surface of an electrically conductive component on a musical instrument may be made into a touch sensitive component by making the electrically conductive component electrically distinct from other components on the musical instrument. Examples of electrically conductive materials may include metals and carbon fiber. Additionally, an electrically conductive material may be added to a surface of a component on a musical instrument to provide the component with touch sensitive functionality.

Components and circuits that are electrically distinct may have inhibited electrical coupling therebetween (e.g., the electrical coupling between a capacitive sensor and a musical instrument output combined with another electrical coupling between a sensor circuit and the musical instrument output may be inhibited), for example, by the arrangement of components or presence of components effecting impedance or reactance, and may be below a threshold that can be perceived by human hearing (e.g., upon processing and playback of sound corresponding to the respective musical instrument output), unless the context gives a different meaning. In an example, a high resistivity material may be applied to an existing component to make the existing component electrically distinct. For an example of such a situation, a rubber grommet may be applied to a touch ring for a part of the touch ring in contact with a musical instrument to make the touch ring electrical distinct from other components in the musical instrument. Part of the touch ring may remain exposed such that a musician may touch a part of the touch ring that is electrically conductive.

A capacitive sensor may be used to detect touch and proximity between the human body of a musician and a musical instrument. Touch and proximity may be measured by the same capacitance sensor. The amount of detected capacitance may differentiate between touch and proximity. For example, as a hand of a musician is placed in further proximity to a whammy bar, a relatively smaller capacitance may be detected. Whereas, when a musician hand touches or is placed in near proximity to the whammy bar surface, the relative capacitance may be larger. Surface area of a musician's hand in relation to a sensor surface may also affect an amount of capacitance. For another example, a finger of a musician touching a capacitive sensor may have less capacitance than when the entire hand of a musician is touching the capacitive sensor. One or more threshold values of sensor readings may be used to determine how much a body part of the musician is touching a capacitive sensor.

Based on a body part of a musician being in proximity or touching a touch sensitive component on a musical instrument, the sound and/or the function of the musical instrument may be changed. For example, when a whammy bar is touched, a deep ambient reverb effect sound may be created. Whereas, when the whammy bar is not touched, a fast clean sound with very little reverb may be created.

A conventional touch sensor circuit may not be well suited for use in sensitive electronic audio environments, such as near the pickups of an electric guitar. A stringed instrument may use magnetic pickups to sense a metal string's movement in a magnetic field. As a pickup output may be amplified, effects like saturation and compression may be added to enhance the instrument audio signal. However, unwanted audible noise from touch sensor circuits may be amplified along with the pickup output thus creating an unwanted sound in the form of noise. Touch sensor circuits may generate electrical noise and also receive electrical noise. Noise may be generated by a touch sensor control circuit charging cycle and oscillation of signals on a touch sensor surface. Noise may be received on a sensor surface from external EMF's (electric and magnetic fields) and from electro static discharge (ESD) events. ESD may also cause low frequency inductive oscillations which may be detected by an instrument's pickups.

For example a musician may hear an ESD click noise when initially touching a touch sensor surface. While holding a touch sensitive surface sensor, charge cycles and oscillations may be heard by a musician. Touch sensor circuitry may be exposed to EMFs of mains power which may be picked up by the musicians body and conducted to the sensor surface. This is particularly a problem when the musician is only touching a sensor surface and not touching grounded audio such as the instrument strings. The measurements of the capacitive sensor may be affected by external noise sources, such as external electro magnetic fields from mains power, data and audio signals, power supply fluctuations, eddy currents, and other electronics nearby. These outside sources of electrical noise may cause inaccurate readings in the capacitive sensor measurements. Instrument pickups may contain coils of wire, magnets, and metal hardware. The pickups may have a parasitic capacitance with the instrument circuits. The pickups may be capacitively coupled to other circuits, such as a sensor circuit. The additional parasitic internal capacitance of the instrument pickups may cause difficulty when measuring the capacitance of a musician's hand that is placed near the pickup due to a musician potentially coupling a capacitance to a sensor when relative to a pickup. Instrument strings are conventionally connected to the same ground node as one side of the pickup's coil on an instrument pickup circuit. External EMFs from mains power and nearby electronics may be coupled to an instrument's audio signal through the body of a musician and the instrument strings. If the strings are connected to the audio ground these noise signals may be reduced. When implementing a touch sensitive surface on a stringed musical instrument, the grounded instrument strings may electrical couple with the touch sensitive surface. The present disclosure may provide sensor designs that aim to reduce the influence of external noise on the sensor measurements while reducing audible frequencies from entering the instrument's audio output.

The present disclosure may provide a sensor design that may detect the presence of a musician's hand when the musician's hands are placed near the pickups of an instrument. The sensor may include a capacitance sensor, a capacitive coupling of a signal sensor, and optical sensing technology.

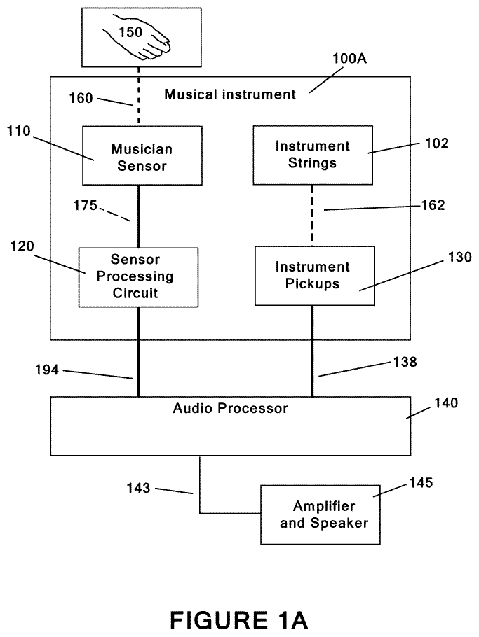

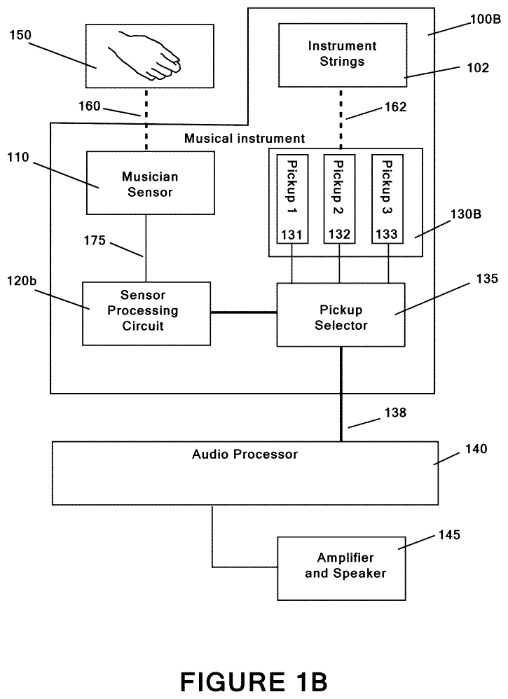

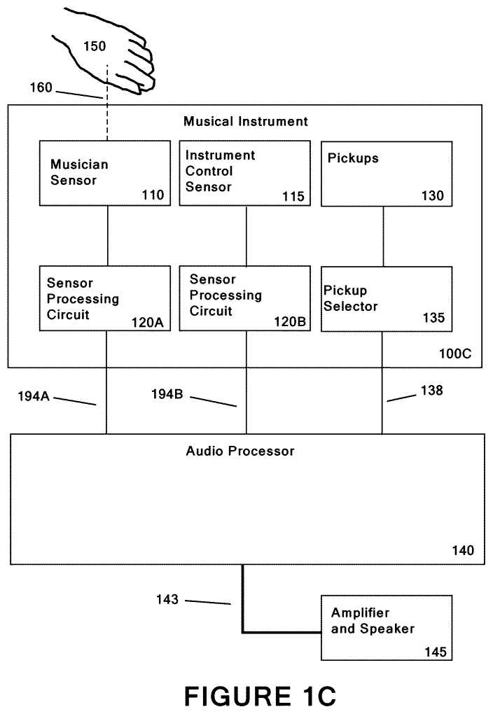

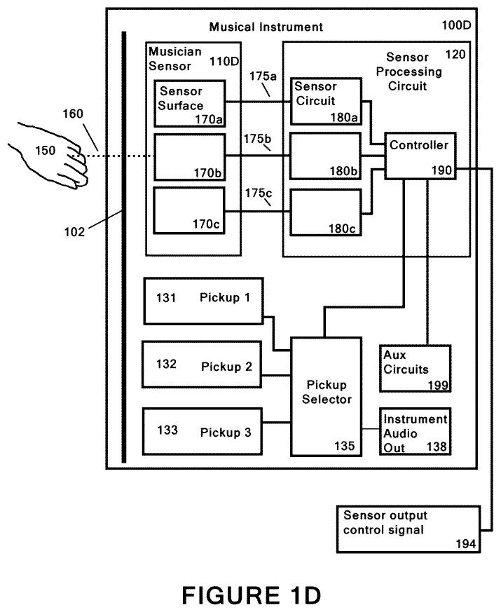

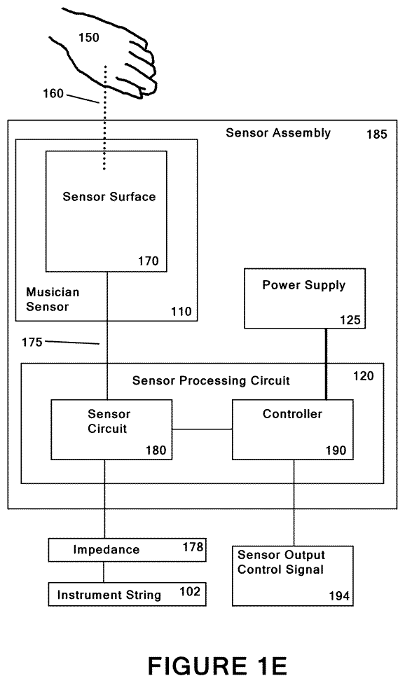

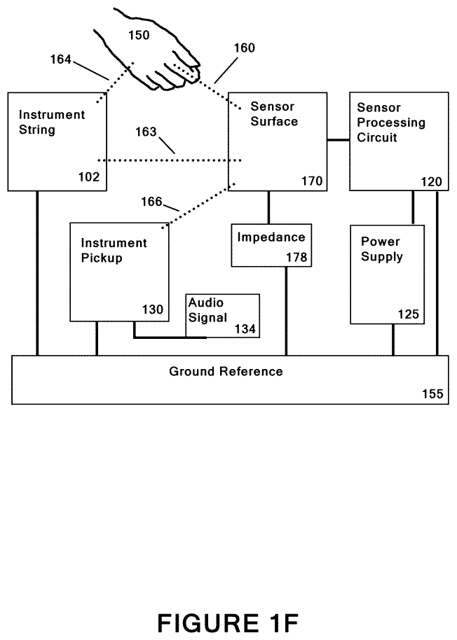

FIG. 1A shows a musical instrument with a touch and proximity sensitive sensor. Musical instrument 100 may include musician sensor 110, sensor processing circuit 120, instrument strings 102, and instrument pickups 130. A musician may play musical instrument 100 by manipulating instrument strings 102 with musician hand 150. Manipulating instrument strings 102 may cause the instrument strings 102 to vibrate. Musician hand 150 may include one or more fingers including one or more fingertips. The vibrating of instrument strings 102 may be sensed by instrument magnetic pickups 130 by modulating magnetic field 162. Instrument pickups may generate instrument audio output signal 138. Instrument pickups 130 may include two or more pickups. For example, instrument pickups 130 may include two pickups on a stringed instrument in different locations.

Musician sensor 110 may detect that the musician hand 150 is in proximity to or touching a touch sensitive component on musical instrument 100. Musician sensor 110 may detect position, gestures, and motions of the musician's hand. An electrical capacitance 160 between musician hand 150 and musician sensor 110 may be detected by sensor processing circuit 120. Musician sensor 110 may be a component of musical instrument 100 that has an electrically conductive surface, and which may form a capacitance with a musician hand when charged with voltage.

Musician sensor 110 may include an electrical or mechanical vibrato system, a whammy bar, a button, a knob, a pick guard, a bridge, a switch, an inlay, a truss rod, pickups and mounting hardware, screw heads and other connecting devices, arrays of elements, combinations thereof. Sensor processing circuit 120 may generate a sensor output control signal 194 proportional to a capacitance 160 of musician hand 150 to musician sensor 110. Proximity may include touching musician sensor 110. Musician sensor 110 may include one or more sensors. For example, musician sensor 110 may include an array of touch sensitive sensors. Musician sensor 110 may be connected to sensor processing circuit 120 by sensor wire 175. In examples, a musician may operate instrument strings 102 and musician sensor 110 independently.

Sensor processing circuit 120 may provide and/or process an electrical signal to musician sensor 110 to measure a capacitance of musician hand 150 to musician sensor 110. Capacitance 160 may be a function of distance between hand and musician sensor 110 surface, as well as surface area of hand and musician sensor surface. A hand 150 may be said to be in proximity with a musician sensor 110 when a change in capacitance 160 is able to be detected by sensor processing circuit 120.

In an example, sensor processing circuit 120 may include a noise filter and a controller used to detect capacitance 160. In another example, sensor processing circuit 120 may include a resonant circuit and a controller used to detect capacitance 160. Sensor processing circuit 120 may generate a sensor output control signal 194 based on the electrical signal generated by musician sensor 110. Sensor output signal 194 may be an analog, digital, or mixed signal. For example, sensor output signal 194 may be a MIDI signal (Musical Instrument Digital Interface).

Musicians may enjoy modulating the sound of an instrument with audio effects. An instrument audio output signal is connected to an audio processor 140 where analog or digital effects may change the sound of the instrument audio. Audio processor 140 may process instrument audio output signal 138 and the sensor output control signal 194 to create a processed audio signal 143. Audio processor 140 may modify instrument audio output signal 138 based on sensor output control signal 194. Audio processor 140 may include a digital signal processor (DSP). Additional functions may be performed by audio processor 140. Audio processor output 145 may be further processed or amplified by a loud speaker system.

Although audio processor 140 is shown external to musical instrument 100, part or the entire function of audio process 140 may be incorporated into the musical instrument 100. Likewise, part or the entire function of signal processing circuit 120 may be incorporated in audio processor 140. In an example, when musician sensor 110 is a whammy bar, audio processor 140 may use the combination of both the rotational position of the whammy bar and musician hand 150 proximity or touch positioning on musician sensor 110.

Processed audio signal 143 may be transformed into sound by amplifier and speaker system 145. Although processed audio signal 143 is shown connected to amplifier and speaker 145, processed audio signal 143 may be routed to any number of other audio components. For example, processed audio signal 143 may be further processed by another audio processor. For another example, processed audio signal 143 may be sent to two other audio components.

Audio processor 140 may include modes of operation based on a position of musician hand 150. For example, when musician sensor 110 is a whammy bar and musician hand 150 is not touching musician sensor 110, pitch detection and pitch shifting effects may be bypassed such that there is a minimal latency in audio processor output signal 143. By minimizing this latency, musical instrument 110 may feel more responsive to the musician. As such, when musician sensor is not activated, musician sensor may have minimal effect on audio process output 145. The bypass may be a software bypass, a hardware bypass, or combinations thereof. When musician sensor 110 detects musician hand 150, the bypass may be removed. When the bypass is removed, a latency may exist due to touch functionality being incorporated in the audio process output 145 signal path. (Further discussion of Audio Processor latency can be found in FIG. 16A discussion below.) When a hand of a musician is touching instrument strings 102, a musician may be grounded by way of the instrument strings 102. A grounded musician may have a different measured capacitance compared to when a musicians hand or body is not touching a grounded point of the instrument. A detected difference in capacitance between a grounded and ungrounded musician may be used to perform different functions.

FIG. 1B shows a musical instrument with a touch sensitive sensor and a pickup selector. Musical instrument 100B may include musician sensor 110, sensor processing circuit 120B, instrument strings 102, instrument pickups 130B, and pickup selector 135. Pickups 130B may sense instrument string 102 movement in magnetic field 162 and generate an audio signal. Pickups 130B may include pickup 131, 132, and 133 at different locations on musical instrument 100B. Pickups may also include piezo electric vibration sensitive type pickups. Pickup selector 135 may select one or more of pickups 131, 132, 133 to drive instrument audio output signal 138.

Musician hand 150 may interact with musician sensor 110 to generate a signal via sensor processing circuit 120B to control pickup selector 135 to select which among pickups 131, 132, and 133 to drive instrument audio output signal 138. For example, musician sensor 110 may include a partially coated whammy bar. Each time a musician touches an exposed part of the whammy bar, a different pickup 131, 132, 133 may be selected. In a scenario, pickup 131 may be selected to drive instrument audio output signal 138. When the musician touches the exposed part of the whammy bar, pickup 132 may be selected to drive instrument audio output signal 138. When the musician touches the exposed part of the whammy bar again, pickup 144 may be selected to drive instrument audio output signal 133.

For another example, musician sensor 110 may include 3 touch sensors physically near each of a respective pickup 131, 132, 133. In a scenario, a screw of each of the respective pickup 131, 132, 133 may be used as a touch sensor. When the musician touches the respective touch sensor for pickups 131, 132, 133, then the respective pickup is selected. In another scenario, when a first touch sensor is near pickup 131 and the musician touches the first touch sensor, pickup 131 may be selected to drive instrument audio output signal 133

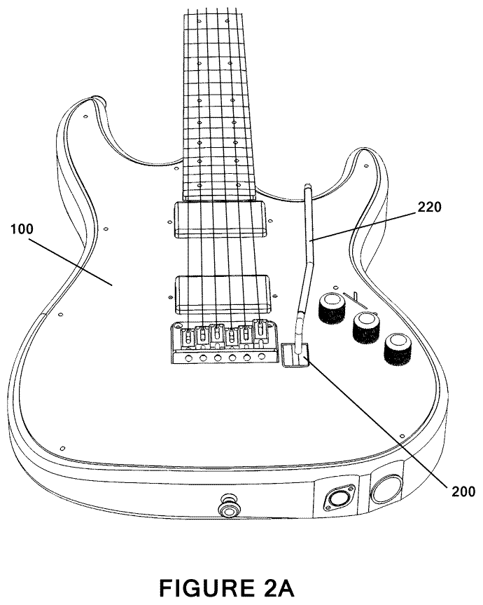

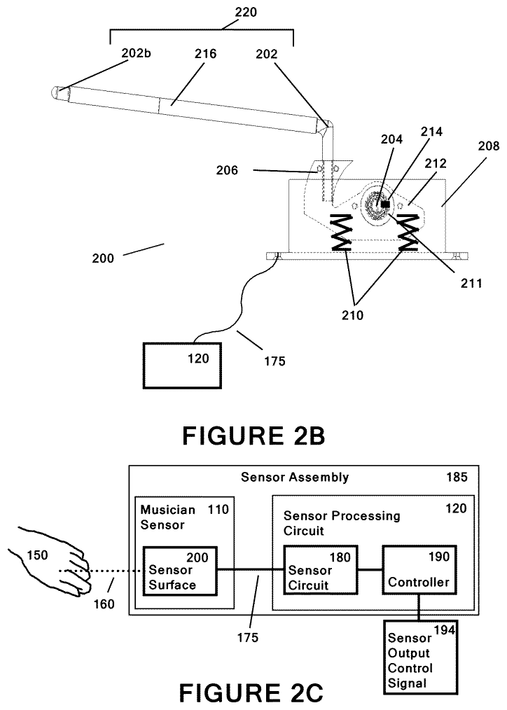

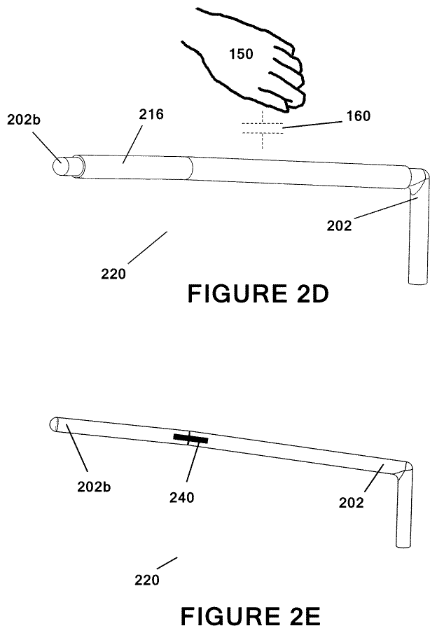

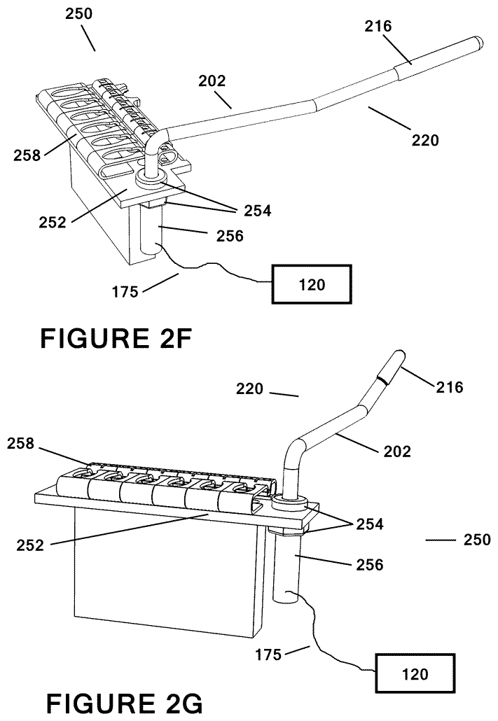

FIG. 1C shows a musical instrument with a touch sensitive sensor and an instrument control sensor. Musical instrument 100C may contain musician sensor 110, sensor processing circuit 120A, instrument control sensor 115, instrument control sensor processing circuit 120B, instrument strings 102 (not shown), and instrument pickups 130. Instrument control sensor 115 may adjust the instrument audio output signal 138 created by instrument 100C. For example, instrument control sensor 115 may be a rotational position sensor (FIG. 2B, part 214) on a vibrato system. Instrument control sensor 115, and sensor processing circuit 120B, may generate instrument control signal 194B.

Audio processor 140 may process instrument audio output signal 138, the sensor output control signal 194A, and instrument control signal 194B, to create processed audio signal 143. Audio processor 140 may modify instrument audio output signal 138 based on changes to instrument control signal 194B or sensor output control signal 194, or both. For example, when instrument control sensor 115 is a rotational position sensor 214 as part of an electronic vibrato system vibrato arm, audio processor 140 may modify instrument audio output signal 138 based on the rotational position of the vibrato arm, or a touch on the vibrato system arm, or both.

FIG. 1D shows musical instrument 100D with multiple touch or proximity sensitive sensor surfaces and multiple instrument pickups. This sensor system may be configured to provide a musician a capability of selection of pickup audio signals by placing a hand near a sensor surface. Sensor surfaces may be located near pickups and a touch or proximity event of each sensor may correlate to the selection of a pickup audio signal. Musician sensor 110D comprising sensor surfaces 170a, 170b and 170c, are electrically coupled to sensor processing circuit 120 by sensor wires 175(a,b,c). Controller 190 may record and compare multiple sensor input values to determine hand 150 position in relation to sensor surfaces 170(a,b,c). Controller 190 may send control signals to pickup selector 135 which may correlate to sensor surface readings of hand position. Pickup selector may use relays, transistors, or analog switch IC, to select one or more audio signals as an instrument audio output signal 138. Controller 190 may also provide controls signals to auxiliary circuits 199 which are correlated to musician sensor hand positions. Auxiliary circuits may include LED lights, sustaining pickup drivers, and other circuits which are part of the instrument. Audio processor 140 may be controlled using hand positions in relation to musician sensor 120. Sensor output control signals 194 may correlate with musician hand positions. An example musician hand is placed near sensor surface 170a. Controller compares sensor circuits 180a, 180b, 180c and determines that hand is closest in relation to surface 170a. Control signals are sent to pickup selector 135 to connect pickup 131 to audio out 138. Additional control signals are sent to aux circuit 199 which may turn on an LED. Sensor output control signals 194 are sent to Audio Processor 140 (not shown) where audio processor modulates the instrument audio signal with an effect, for example increasing reverb. When musician hand is moved closer to sensor surface 170c, new signals are sent to pickup selector, LED, and audio processor. For example pickup 133 is selected, LED is turned off, and audio processor reduces a reverb effect. Sensor circuit 180(a,b,c) may be of several types. As discussed below Self capacitance and resonant sensing circuits my be used. Signal sensor and oscillator sensors may also be used. Instrument strings 102 may be driven as part of a sensor surface. FIG. 1E shows sensor assembly 185. This assembly may be used as part of a touch and proximity sensitive sensor system for a musical instrument 100. Assembly 185 contains musician sensor 110 and sensor processing circuit 120 and power supply 125. Musician sensor 110 may be comprised of one or more electrically conductive sensor surfaces 170. Sensor processing circuit 120 may contain one or more sensor circuits 180 and controller 190. Sensor wire 175 may connect Sensor surface 170 to the sensor circuit 180. Power supply 125 may supply current to the sensor processing circuit. Power supply 125 may be a battery or an external supply. A clean and filtered power supply may important for accurate sensor readings and to prevent power supply noise from coupling to the pickups 130 and audio circuits. Sensor circuit 180 may be electrical components designed to condition signals between controller 190 and sensor surface 170. These components may filter or condition external noise from sensor surface 170, or they may filter or condition signals generated by controller 190. Sensor circuit 180 may amplify or limit a signal present on sensor surface 170. A difference of electrical potential between sensor surface 170 and musician hand 150 may cause a capacitance 160 to occur. Sensor processing circuit 120 may be designed to measure capacitance 160 and output corresponding sensor output control signals 194. Capacitance 160 may change according to surface area of hand 150 and sensor surface 170, distance between them, and hand and sensor relation to electrical ground. Instrument String 102 may be in contact with musician's hand 150. Instrument string 102 may be electrically grounded to reduce noise in instrument audio. When a musician would like to use the touch sensor functions while also touching an instrument string, an impedance 178 may provide controller 190 electrical separation between the surfaces.

FIG. 1F shows a diagram of capacitive fields between sensor surfaces and instrument parts. Instrument 100 may comprise the circuits pictured in FIG. 1F. Instrument string 102 is connected to ground reference 155. Instrument pickup 130 may be a coil type electromagnetic pickup with one side of the coil connected to ground 155 and the other side generating an audio signal 134. Sensor processing circuit 120 is powered by power supply 125, both of which are connected to ground 155. Sensor processing circuit may impart signals onto sensor surface 170 so as to measure a capacitance 160 between musician's hand 150 and sensor surface. String to sensor capacitance 163 and pickup capacitance 166 may also be present to the sensor surface 170. Hand to string capacitance 164 and parasitic capacitance with other hardware may be present. Impedance 178 provides an electrical separation between sensor surface 170 and ground 155 which includes instrument string 102. Signals on the sensor surface 170 may be reduced by impedance 178 providing electrically distinct surfaces for capacitance 163.

When musicians hand 150 is not present, sensor surface may calibrate a capacitive measurement from a total of all capacitance sensed, including string to sensor capacitance 163 and pickup capacitance 166. When musicians hand is present but not touching instrument string 102, sensor processing circuit 120 may measure the series capacitance of string to hand 164 and hand to sensor capacitance 160, along with the parallel capacitance of pickup capacitance 166, string to sensor capacitance 163, and parasitic capacitance of the system. When musician's hand 150 is touching instrument string 102, a greater capacitance may be sensed by sensor processing circuit 120. The musician's hand and body become part of the ground reference 155 which may contribute to a greater surface area for capacitance to form and may improve dielectric properties of the musician's body. Sensor processing circuit may be configured to detect different threshold measurements of a grounded musicians hand 150 and an ungrounded hand 150.

FIG. 2A shows a musical instrument with an electronic vibrato assembly. Whammy bar assembly 220 is a part of electronic vibrato assembly 200. Whammy bar assembly 220 is a lever arm used to control the rotational position of a moving portion of electronic vibrato assembly 200. FIG. 2B shows a side view of a touch sensitive electronic vibrato assembly which may be part of a touch or proximity sensor assembly. Electronic vibrato assembly 200 may be secured to musical instrument 100. Electronic vibrato system 200, may include whammy bar 220, and may be constructed to contain electrically conductive materials. Sensor processing circuit 120 is connected to vibrato assembly 200 using sensor wire 175.

FIG. 2C shows a function block diagram of an electronic vibrato assembly serving as a sensor surface which is a part of a sensor assembly.

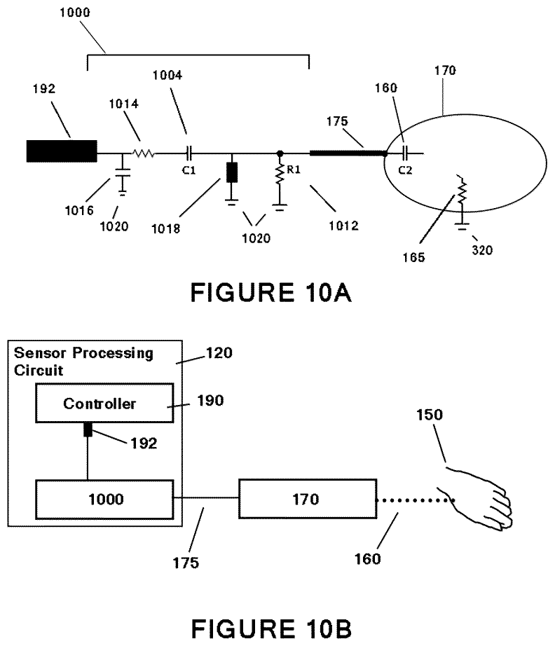

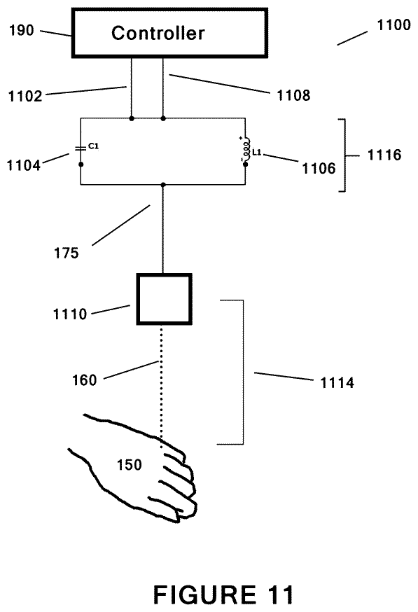

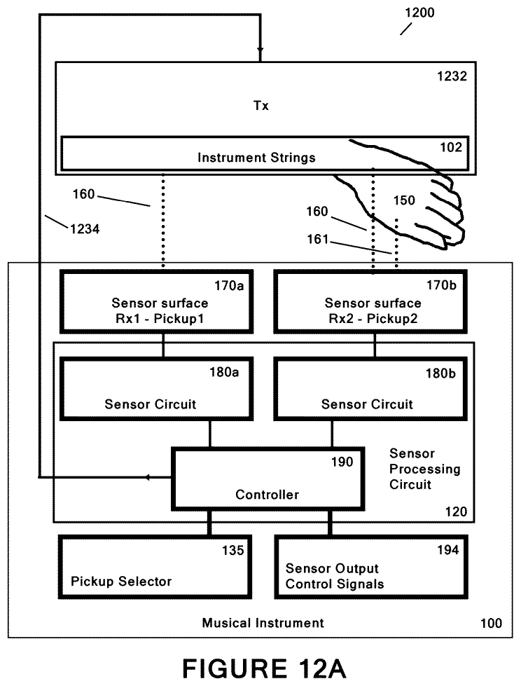

Electronic vibrato assembly 200, including whammy bar assembly 220, may serve as a musician sensor 110. Vibrato assembly 200 may be connected to sensor processing circuit 120 using sensor wire 175. Vibrato assembly 200 in combination with sensor processing circuit 120 may form part of a sensor assembly 185. Conductive lever 202 may serve as a sensor surface 170. Signals from sensor processing circuit 120 may effect a capacitance 160 between whammy bar assembly 220, and musician hand 150. Sensor circuit 180 may be of many types, including self a capacitance circuit 1000 (as discussed below in FIG. 10), resonant circuit 1100 (as discussed below in FIG. 11), a Signal Sensor (FIG. 12A), a FET gate capacitive sensor, a manufactured capacitive sensor IC, a capacitive divider circuit or other types of electrical touch sensor circuits.

In an example, FIG. 2B shows sensor wire 175 may connect to fixed, non-rotating, chassis 208. This provides a non-rotating attachment point which prevents damage to sensor wire 175 through work hardening, movement, or friction. A hub 212 and an extension 206 rotate (clockwise and counterclockwise as shown) about an axis 204. A rotational position sensor 214 may be connected to controller 190 to measure the angle of hub 212 rotation. Electrical conductivity is maintained from the sensor wire 175 to the chassis 208, and then to the rotating parts of the assembly hub 212, through springs 210. Conductive bushing or conductive ball bearing 211 may also be used to maintain electrical conductivity from the chassis 208, through the axis 204, to the hub 212. Whammy bar assembly 220 is disposed in a hole in extension 206. Whammy bar assembly 220 may be made to contain a conductive lever 202. An electrically conductive connection is made between the hub 206, and the lever 202, through the hole in extension 206. Conductive lever 202 may be used to rotate the vibrato system about an axis 204. Electrical continuity is maintained from conductive lever 202, through the rotating components of the extension 206 and hub 212, through springs 212 (or through conductive bearings 211 and axel 204), to non-rotating chassis 208, and sensor wire 175, which connects to sensor circuit 180. Conductive lever 202 may serve as a touch or proximity surface for a musician's hand to interact with the sensor circuit. In an example, sensor wire 175 may be omitted if sensor circuit 180 is attached directly to electronic vibrato assembly 200. Sensor wire 175 may be a flexible wire or it may be a different conductive material such as a PCB trace, conductive metal or hardware, or a conductive coating. FIG. 2D shows a whammy bar assembly which may be a part of an electronic or mechanical vibrato system. Conductive lever 202 may serve as sensor surface 170 which is a part of sensor assembly 185. A coating 216 may be added to whammy bar assembly 220. The coating may be a dielectric coating material of high electrical resistance. Plastic, rubber, paint, wood, foam, and many other non-conductive, highly resistive, coatings may be used to make dielectric coating 216.

A musician's hand may contact the coating 216 and rotate the vibrato system. When touching the coating 216, the vibrato whammy bar and hub may be rotated normally without activating the touch sensor. Touch sensor surfaces on the conductive lever 202 and exposed portion of conductive lever 202b may be operated independently of the rotation of the lever around axis 204. Coating 216 is pictured as a cylindrical coating over bar 202, but it may be shaped differently to provide different touch ergonomics. Some examples of alternative shapes of coating 216 may be a perforated coating, a tubular coating of several segments, a coating of only a tip of whammy bar, or a coating on the top or bottom half of cylindrical conductive bar 202.

The coated portion 216 of whammy bar assembly 220 may function as a proximity sensor to sense hand 150. Capacitance 160 may pass through coating 216. The thickness and shape of coating 216 may be varied to effect proximity sensing in the sensor circuit. Multiple types of coatings may be used to cover different portions of the sensor area. Materials of variable resistance, such as conductive foam, rubber, or paint, may be used alone or in combination, to effect sensor proximity or resistive readings when the material is touched. These coatings may function as part of a pressure sensitive coating to whammy bar assembly 220 because a greater pressure of hand 150 generally increases the surface area of the sensor capacitance, increasing the capacitance amount sensed. Touch sensitive whammy bar assembly 220 may be constructed with or without coating 216. An uncoated whammy bar assembly 220 may be used to bypass effects or to engage effects only when touch sensor is being operated. The touch sensor of an uncoated bar assembly 220 may act as a momentary or a latching switch to engage effects. When whammy bar assembly 220 is constructed with a coating 216, additional resonfunctions of rotating the lever without operating the touch sensor is provided.

Proximity and touch events of the sensor circuit may be set at different thresholds. The sensor may detect a proximity event at a first threshold value. When a higher capacitance is sensed, a second threshold value may indicate a touch event. Multiple thresholds may be configured as part of the sensor system. Different output signals may be associated with touch and proximity events at different threshold readings. For example the system may be configured to send a first MIDI signal in response to a variable proximity event. And the system may send a second MIDI signal when a second capacitance threshold is passed indicating a touch event. FIG. 2E shows a touch sensitive whammy bar assembly. Additional component 240 is located between conductive surface 202 and 202b. The additional component 240 may electrically differentiate sensor surface 202 from 202b. Components may be one or many and include capacitance, resistance and inductance. These components may influence how sensor surfaces respond to sensor processing circuit 120. In an example, if sensor processing circuit uses resonance or frequency of oscillation to measure capacitance, the additional components 240 capacitance and inductance may change the resonant frequency of sensor circuit 180. Sensor processing circuit may measure a first frequency when hand 150 touches surface 202, and a second frequency when hand 150 touches 202b. 202b having the additional components in series with the resonant sensor and hand 150. Additional components 240 may also include an inductor or a resistor which may further effect the circuit or the resonant frequency. In an example, additional components 240 provide resistance between surface 202 and surface 202b. An added resistance may be combined with the resistance of a musicians hand when touching a sensor surface. Hand 150 may serve as a resistive path to ground when the musician's body is touching grounded instrument strings. A grounded hand 150 touching 202b will place the added component's (240) resistance in series with the resistance of the musicians hand (or body) 150. The sensor circuit 180 will detect a first resistance of the hand or body touching surface 202, and a second higher series resistance when touched at conductive surface 202b, due to the additional component 240 in series. In an example, additional components 240 provide capacitance (and inductance). Sensor processing circuit may measure a different capacitance value when hand 150 touches surface 202b than when hand 150 touches surface 202. When a musician hand 150 touches conductive surface 202b then the additional component capacitor 240 may be in series with the capacitance of the musicians hand. Total capacitance of the touched sensor surface 202 may be different from that of touched surface 202b. Controller 190 may differentiate a hand 150 touch on conductive lever surface 202 from a hand touch on conductive lever surface 202b, and output corresponding control signals 194.

FIG. 2F shows a touch sensitive mechanical vibrato system from a side perspective. FIG. 2G shows a touch sensitive mechanical vibrato system 250 from a rear perspective. The drawings depicts a Fender style vibrato system, however many other systems could be used, including a Floyd Rose, a Khaler, a Bigsby, a Vega, and many other designs. Touch sensitive functionality may be added to a mechanical vibrato system however some modifications may need to be made to separate the electrically conductive connection between the mechanical whammy bar lever and the strings. This may be done by using non conductive (dielectric) materials between the conductive whammy bar and the conductive strings. An example shown in FIG. 2F and FIG. 2G, uses a dielectric collar around the whammy bar mounting hardware. In either case, a conductive or capacitive connection may be made between the conductive whammy bar and the sensor circuit. Additionally a resistive or dielectric connection may be established between the whammy bar and the strings in order to prevent the strings from connecting with the sensor circuit. Whammy bar assembly 220 is mounted to base plate 252 using dielectric material 254. Dielectric material 254 is preferably a ferrule designed to prevent electrical contact between conductive lever 202 (which serves as touch sensitive sensor surface 170), and other conductive parts of mechanical vibrato system 250, such as base plate 252.

A signal wire 175 may be attached to conductive cylindrical bore 256. Electrical continuity may be maintained between a non rotatable conductive cylindrical bore 256 and rotatable whammy bar assembly 220 via direct contact or capacitive coupling. Base plate 252 may be grounded along with instrument strings. It is important that sensor surface 202 of whammy bar assembly 220 is electrically distinct from the grounded strings so that a touch event on the whammy bar can be distinguished from a touch event on the strings. In this way a traditional vibrato system may gain function of a touch sensor.

Other means of electrically separating strings from touch sensor surfaces may be used. For example dielectric string saddles 258 may isolate strings from a touch sensor surface such as conductive lever 202.

In an example, a musician may use an electronic vibrato system and control three or more parameters simultaneously. A first signal may be associated with a touched and an untouched state. The first signal may control a processor bypass state while also controlling a processor parameter. For example a first signal may control a pitch shift bypass state as well as change an octave of pitch shift frequency. A second rotational signal may control a processor bypass state, for example a pitch shifter bypass state. A third rotational signal may control a parameter of a processor. For example a third signal may control an amount of frequency that is changed by a pitch shifting processor. In this configuration, a touch sensitive vibrato system may provide a musician with many different output control states. A first untouched state, a second touched and non rotated state, a third touched and rotated state, and a fourth rotated and untouched state. The fourth state may make use of a dielectric coating on the whammy bar allowing a musician to touch the bar without activating a touch sensor threshold. A musician may lightly touch a dielectric portion of a coated whammy bar and impart a capacitance detected as proximity. By increasing the touch surface of the hand on the dielectric portion of the whammy bar, a musician may also increase the capacitance and proximity measured by the touch sensor. In this way a proximity and touch sensitive whammy bar sensor system may be able to measure the amount of surface contact a musician has made while holding a whammy bar. Output signals may be correlated based on these proximity values measured. Controller 190 may set thresholds on the sensor circuit inputs that are used to determine corresponding output signals. Hysteresis may be added to the threshold of the input signals when determining a touched state of the sensor. A controller may use other types of signal filtering or data smoothing of the sensor circuit output which may be useful for conditioning the controller output signals.

Controller 190 may be connected to a wireless transmitter to communicate signals to an external processor. Popular wireless devices may include bluetooth, wifi, and other radio signals. Controller may output signals to other processors or devices attached to the instrument. These may include relay switch modules, sustaining pickups, lighting devices, and other electronics. A controller may be configured to output MIDI signals or CV (control voltage) signals that correspond to the state of the sensor.

A resting whammy bar, as part of an electronic vibrato system, may have a resting zone which is a small number of rotational sensor position outputs near the resting position. A rotational sensor controller may be configured so that no output signals are sent when a rotational position is measured in a resting zone. A threshold may be defined by a controller to define a resting zone. A resting zone may function to prevent background electrical noise in an electronic vibrato system's rotational sensor from sending control signals to a processor. Controller 190 may not send a corresponding sensor output control signal 194 to an audio processor 140 when rotational sensor 214 readings of movement and electrical noise do not cross the threshold of a resting zone. A resting zone may also prevent small vibrations and small rotational movements of the vibrato system from sending control signals to an audio signal processor 140. Whammy bar output states
State 1) untouched and not moving (no human body involved, unused state)
state 2) touched and not moving
state 3) touched and moving
State 4) untouched and moving (using coating)
State 5) Proximity sensed through coating, untouched, not moving
State 6) proximity sensed through coating, untouched, moving
Others) there can be other states if we combine resistors and other sensors

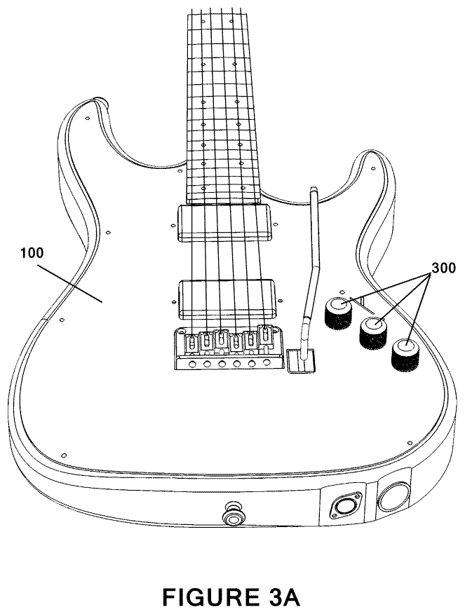

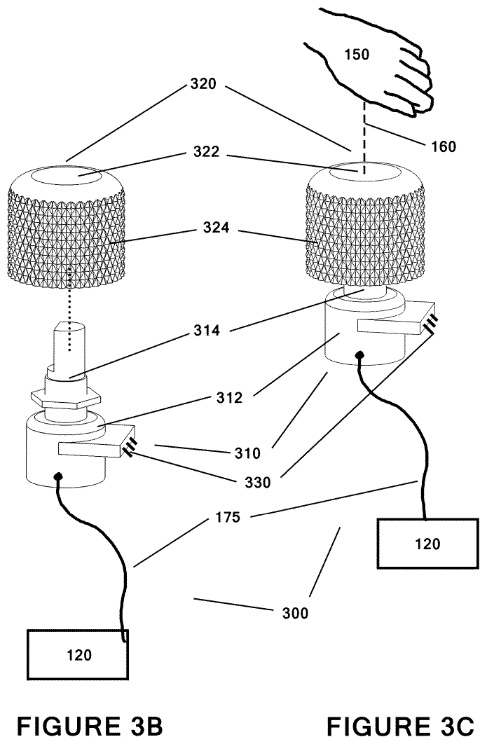

FIG. 3A shows a musical instrument with a touch sensitive knob assembly. This knob assembly combines the resistive rotational sensor of a traditional potentiometer with an added touch and proximity sensor.

FIG. 3B shows an exploded view of a knob assembly. FIG. 3C shows an assembled view of a knob assembly. Know assembly 300 may, including a knob 320 and a potentiometer 310. Sensor wire 175 connects potentiometer chassis 312 to a sensor circuit 180. Conductive shaft 314 may rotate inside a cylindrical hole in chassis 312 which may be a bushing around shaft 314. Chassis 312 and shaft 314 are in contact inside the bushing. They may be constructed out of conductive material and are electrically coupled. Knob handle 320 mounts onto rotatable shaft 314 so that a rotational motion of knob handle 320 is coupled to shaft 314. An electrical continuity is maintained between knob handle 320 and conductive shaft 314 and conductive chassis 312 so that all three parts may become touch and proximity sensitive surfaces when connected to sensor processing circuit 120 via wire 175.

Knob handle 320 may have a coated portion 324 and an uncoated portion 322. Coating 324 being preferably a dielectric material. A musician may operate the rotational angle of the knob handle by touching the coated portion 324 without touching the uncoated portion 322. Likewise a musician my operate the touch and proximity sensitive portion of the knob 322 without changing the rotational angle of the knob handle 320.

Potentiometer terminals 330 connect to the resistive elements inside the potentiometer. Potentiometer chassis 312 typically functions as an electrical shield to prevent external EMFs, particularly audible mains noise, from entering the chassis and effecting a signal inside. If the chassis 312 is grounded, external noise may also be grounded. Touch sensor circuits 180 may also shield signals inside the potentiometer from external noise. Self capacitance sensor circuit 1000 features a resistor 1012 through which EMF signals may be grounded. Resonant sensor circuit 1100 features a band pass filter which may also filter stray EMFs entering the chassis.

A Self Capacitance sensor circuit in this disclosure (described in FIG. 10A) provides a means of grounding a potentiometer through a resistor. The resonant sensor circuit (FIG. 11) also serves as a bandpass filter and connecting it to the potentiometer may filter external EMFs.

Coating 324 may be plastic, rubber, paint, wood, and many other dielectric materials which may prevent a touch threshold from being reached on the sensor surface. This configuration may allow a musician to rotate the knob traditionally by gripping the dielectric coating on a cylindrical surface. The musician may operate the touch sensor by touching the exposed surface of the knob. The touch and rotational controls of the touch sensitive potentiometer may operate independently.

A example, musician may operate the dual functions of a touch sensitive knob. A rotation of the knob may control volume and a touch sensor may be configured to mute an instrument audio output signal. In another example a touch sensor may be configured to send a corresponding sensor output control signal 194 to an audio processor, which may modulate instrument audio with effects. In an example a midi signal may be configured to activate a tuner device. In another example a knob touch sensor may activate an auxiliary circuit 199 such as a sustaining pickup circuit.

Touch sensitive knob assembly 300 may be configured to provide multiple functions to the resistive rotational potentiometer 310. Touching the touch sensor surface 322 may change the function of the knob rotation by switching the terminal connections on the potentiometer to a different circuit. For example, a touch sensitive knob and potentiometer may be configured to function as an instrument volume knob for an audio signal when it is rotated and not touched. However when touched the knob rotation has a new function, for example a digital effect parameter control. In another embodiment, a double gang potentiometer may be used. A touch sensor may be configured to activate a switch selecting between the potentiometer gangs.

In another configuration, potentiometer terminals are connected to a controller analog digital converter (ADC). Data about the knob position and function may be stored in a controller. When a knob touch sensor is activated, the function of the knob may be changed by the controller and the untouched position data may be stored for later. For example a knob may be configured to send signals on a first MIDI channel when untouched, and a second MIDI channel when touched.

A rotational encoder may be used instead of a potentiometer 310. An encoder's digital position may not be associated with a physical point in rotation and multiple digital positions may be in operation for a single encoder device. A first encoder digital position may be recorded in memory of a controller while touch sensor is untouched. A second encoder digital position may be recorded while touch sensor is touched.

A touch sensitive knob encoder may be configured to send a first rotational position output signal when untouched, and a second rotational output signal when touched, and a third output signal corresponding to the touch sensor status.

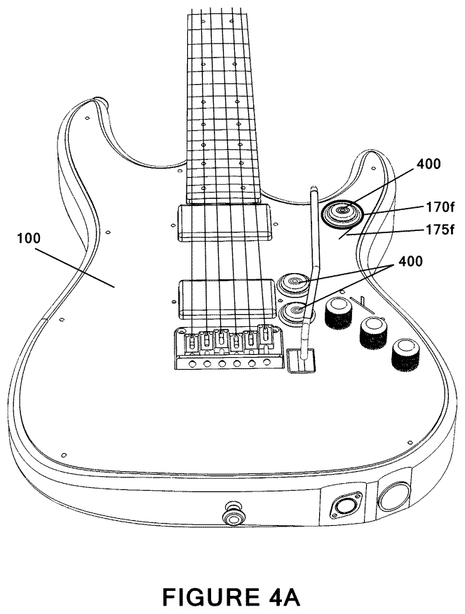

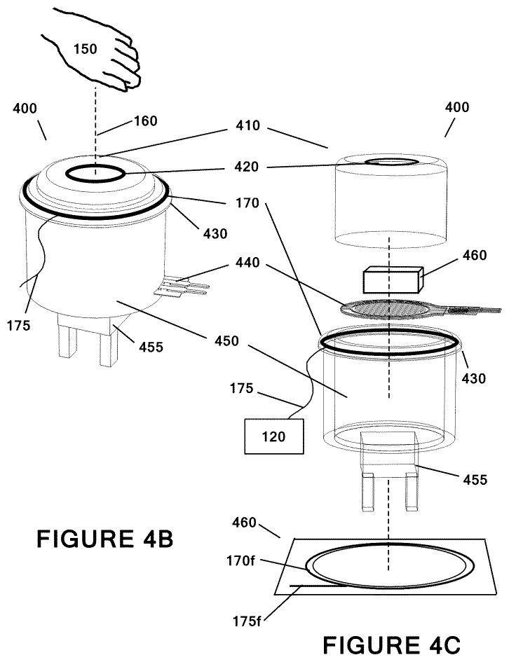

FIG. 4A shows a touch and proximity sensitive button assembly attached to a musical instrument. Receiving sensor surface 170f and sensor wire 175f are depicted as part of a an instrument pickguard. FIG. 4B shows a touch and proximity sensitive button. FIG. 4C shows an exploded view of a touch and proximity sensitive button. The drawing depicts a pushbutton style switch, however other types of controls may use a similar sensor construction.

A button with a switch may have an ON and an OFF state. A pressure sensitive button may provide a range of values from a pressure sensitive resistive, capacitive, or inductive, element. When a touch sensor is added to a button switch or pressure sensitive control, additional functionality is provided. A touch sensitive button control 400 may have three states, Untouched and OFF, Touched and OFF, and Touched and ON (or with variable pressure). This may be useful for controlling a musical expression. A touch sensitive push button may detect the touch of a hand first, before a button switch or pressure sensor has been activated.

In an example, a touch event on the sensor may activate a delay effect, and then a pressure event may increase the feedback parameter of the delay effect. When pressure is removed and touch sensor is untouched, delay effect may turn off. In this way a musician may control both the engagement of the effect and a parameter of the with the same control.

Touch and proximity sensitive control 400 may be a pushbutton type control which may mount to an instrument face. Chassis 450 may be inserted into an instrument body 101 or pickguard 106 with movable button cap 410 and chassis lip 430 remaining visible. Pushbutton construction may use a contact switch 455 to determine when a button cap has been pressed, making or breaking an electrical contact inside the switch. Another pushbutton switch design may use a pressure sensitive sensor 440 to determine when and how hard button cap is being pressed. A spring or spring like material (foam, rubber) 460 may return the button cap 410 to a resting unpressed position.

Sensor surfaces 170 may be added to the button assembly. Chassis lip 430 may contain a sensor surface 170. This sensor surface 170 may be an electrode or a coil. Sensor wire 175 may connect the sensor surface 170 to a sensor circuit 180. To increase sensor performance, an additional conductive sensor surface 420 may be located in or on the button cap 410. This sensor surface may be electrically coupled to sensor surface 430 through capacitive coupling or through conductive materials.

In another configuration, receiving sensor surface 170f is placed on the receiving body 460 where button 400 is mounted. Sensor wire 175f may connect to a sensor processing circuit 120. Receiving body 460 may be a printed circuit board (PCB) and receiving sensor surface 170f and sensor wire 175f are conductive traces on the PCB. Receiving body 460 may also be a pickguard 106.

When a hand 150 is placed on or near the button cap 410, a capacitance 160 or a signal coupled by capacitance 160 may increase or decrease depending on the type of sensor circuit 180 used. This change may be sensed by controller 190 as a touch event. A second signal may be sensed if the button cap 410 is pressed. Controller 190 may send a sensor output control signals 194 in association with sensor inputs. Audio processor 140 may receive control signals and modulate audio.

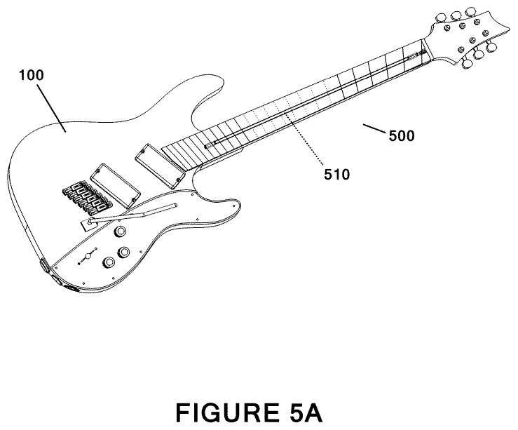

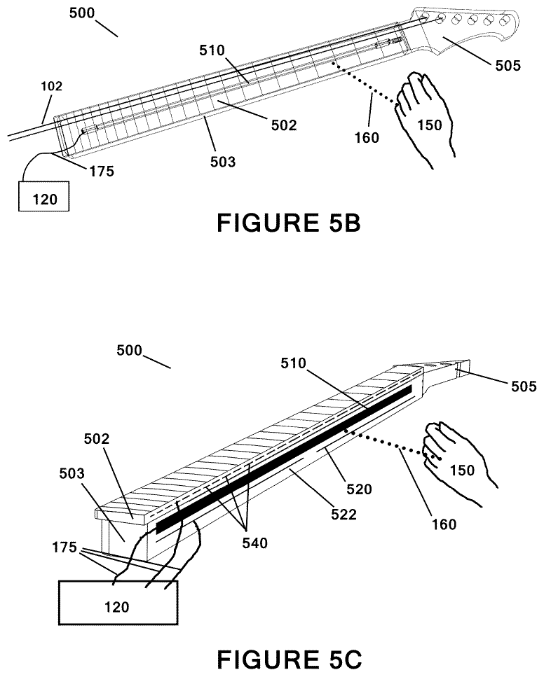

FIG. 5A shows a truss rod in a musical instrument. Many stringed musical instruments contain hardware called a truss rod used to control curvature and tension of an instrument neck. A truss rod may be constructed of conductive material. Combining a capacitive proximity sensor with a truss rod may provide a musician with a proximity sensitive instrument neck. FIG. 5A shows musical instrument 100 with truss rod and neck sensor assembly 500 and truss rod 510. Instrument strings 102 are not shown and instrument neck is partially transparent to show truss rod positioned inside neck. FIG. 5B shows a bisected view of a musical instrument neck. FIG. 5C shows another bisected view of a musical instrument neck. Truss rod and neck sensor assembly 500 comprising neck 503, fretboard 502, headstock 505, truss rod 510, and strings 102. Sensor processing circuit 120 is connected to conductive truss rod 510 using sensor wire 175. FIG. 5C depicts other sensor surfaces 180 mounted in the neck. Fret position sensors 540, upper neck sensor 522 and lower neck sensor 520 are shown connected to processing circuit 120. These sensors may provide a sensing system which may detect the presence and position of a musicians hand in relation to the neck. Controller 190 may send sensor output control signals 194 in association with sensor inputs to an audio processor 140.

Proximity and touch sensitivity of an instrument neck may be useful for control of musical parameters. For example volume may be controlled by the musician by placing a hand on an instrument neck. When the instrument is set down and no longer played, volume may be reduced by the neck sensor system. In another example a distortion effect may be controlled by a musician's hand motions. A lower neck sensor may be associated with less distortion and an upper neck sensor may be associated with more distortion. Truss rod and neck sensors may be constructed with circuits that are optimized for proximity sensing. Resonant capacitive sensor circuits and Oscillator sensor circuits may be used. Heterodyne oscillator capacitive sensor circuits may detect greater proximity distances. An oscillator sensor circuit description can be found later in this disclosure.

Multiple sensor circuits may be arranged in a matrix and networked to provide multiple touch sensitive points. A matrix may contain an overlapping grid of touch sensitive sensors. A touch point may be determined by a change in capacitance of two or more sensors. Multiple points may be detected simultaneously by a matrix sensor system.

A sensor matrix may be constructed using several sensor types. Preferably an IC designed to detect mutual capacitance may be connected to the sensor surface. Many suitable ICs are known in the art. A matrix of sensors may be located on an instruments body, or made to be part of an instrument's hardware. For example a matrix may be part of a pickguard, or made from a circuit installed in an instrument body.

These related art examples use prefabricated sensor components which are mounted as rectangular forms on an instrument body. People may find the rectangular form factor does not agree with the aesthetics of a curved instrument design. The present disclosure teaches many ways to conceal touch and proximity sensors into traditional instrument hardware. FIG. 11a and FIG. 11b teach a system which may conceal grid like sensor surfaces 170 using traditional instrument parts.

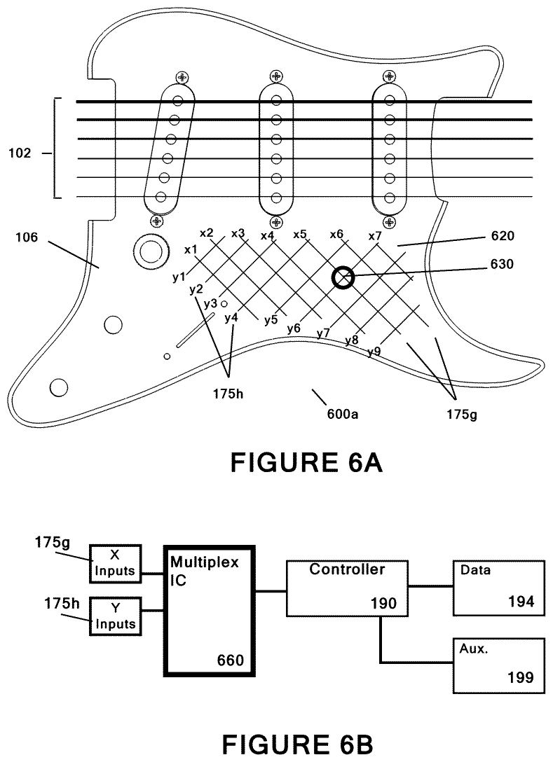

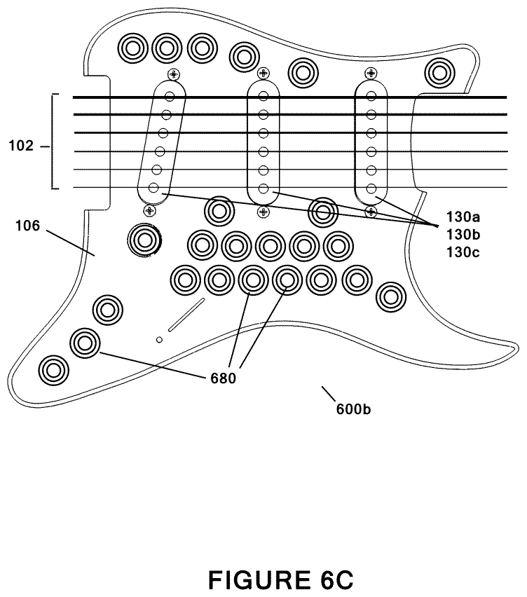

FIG. 6A shows a sensor array of a musical instrument. Multiple sensor surfaces 170 may be arranged in a grid like pattern on an instrument surface. The Instrument surface may be an instrument body 101 or pickguard 106, or it may be a different part of an instrument. These sensor surfaces 170 may be made of conductive material. They may each be sensor wires 175. In this case sensor wires 175g and 175h are the same as sensor surface 170. Preferably a first parallel group of sensor wires 175g overlaps a second group of sensor wires 175h, with an insulator in between them. In FIG. 6A, a first group of sensor wires 175g contain all wires labeled x1 through x7. A second group of sensor wires 175h contain all wires labeled y1 through y9.

A controller 190 may interpret signals from two or more sensors simultaneously. The location of a touch event may be determined from readings in two dimensions on the sensor grid 620. For example a touch event at a touch location 630 may be determined by the combination of an “x5” event on sensor surface 175g and a “y6” event on sensor surface 175h.

In a preferred embodiment, the sensor wire grid 620 is part of a printed circuit board (PCB). Each sensor wire may be a trace on a PCB board. A multi layer PCB may provide separate layers for sensor surfaces separated by the PCB substrate. A ground plane may help to isolate stray capacitance and improve sensor resolution.

Pickup sensors 650 may be part of a pickguard 106 sensor array 600. Pickup sensors 650 may be capacitive sensor surfaces 170. A larger amount of capacitance may be present between pickups 730 and sensor surfaces 650, making it difficult to detect a smaller capacitance 160 between hand 150 and pickup sensors 650. In this situation, a signal sensor (##) may be a preferable type of sensor circuit 180.

Pickup sensors 650 using signal sensor (NUMBER) circuitry may be created with a transmitter Tx and receiver Rx. FIG. 11a shows instrument strings 102 crossing over pickups 730 and pickup sensors 650. A signal generator, such as an oscillator 1630, or a controller 190, may impart a high frequency inaudible signal onto strings 102. This signal may be detected by the pickup sensors 650 through capacitive coupling. A musicians hand 150 may be placed in contact with signal transmitting strings 102, and above a pickup sensor 650. The hand 150 may increase the surface area of the transmitter, which may increase the capacitive coupling, between the strings 102 and a pickup sensor 650.

FIG. 6B shows a function block diagram of a multiplex IC connected to a controller. Multiplex IC 660 may process a large number of sensor input channels and process them into a digital signal for the controller 190. Pickup sensors 650 also connect to the controller 190 input terminals. This system may use a mix of digital and analog inputs to the controller 190. Oscillator 1630 is driven by controller 190 to generate a frequency for the signal sensor Tx. Pickup sensors 650 and sensor grid 620 may be processed together by controller 190 to determine more precise information about hand 150 position.

Controller 190 output signals to switch module 192 may connect pickups with audio outputs. Digital information, such as MIDI, about hand location and pickup status may be sent to Data output 194

FIG. 6C shows another sensor array of a musical instrument. Instrument surface 610 may contain multiple discrete sensor surfaces 680. These sensor surfaces 680 may be the equivalent of sensor surface 170 in FIG. 1b. They may be conductive surfaces or coils and may each be connected to a sensor circuit 180 through a sensor wire or PCB trace 175.

The discrete sensor surfaces 680 may be arranged in a pattern or strategically arranged to sense various areas of an instrument. Sensor surfaces may be combined with pickup sensors 650 as part of a sensor array 600. Each sensor surface may sense touch or proximity. Multiple sensor values may be simultaneously monitored by controller 190 which may detect hand 150 positions. Gestures such as swipe, strum, tap, and proximity movements may be understood by the controller to generate control signals.

Strings 102 may be part of a signal sensor system (NUMBER) where a signal is transmitted from strings 102 to discrete sensors 680 through a human body.

A Signal Sensor may be made using transmitter and receiver circuits. A signal sensor may use capacitive coupling between X and Y sensors on a grid. Signals from an instrument's electrical ground or strings my also be coupled to sensor receivers by a musician's hand.

Networks of self capacitance sensors and networks of resonant sensors may also be constructed. Controller 190 may determine hand 150 gestures by measuring changes in the sensor state of multiple sensors over time.

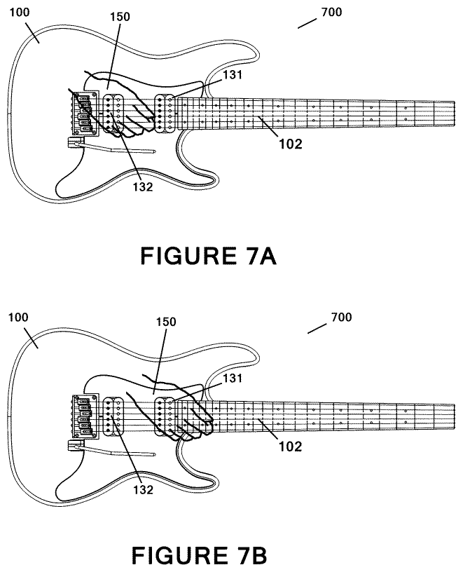

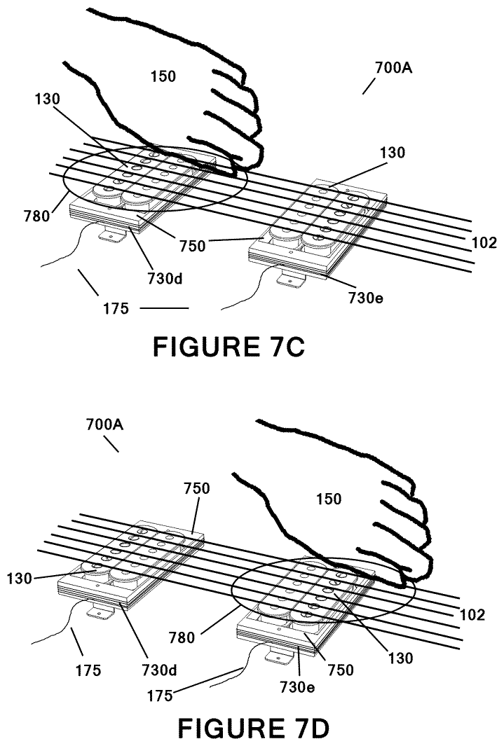

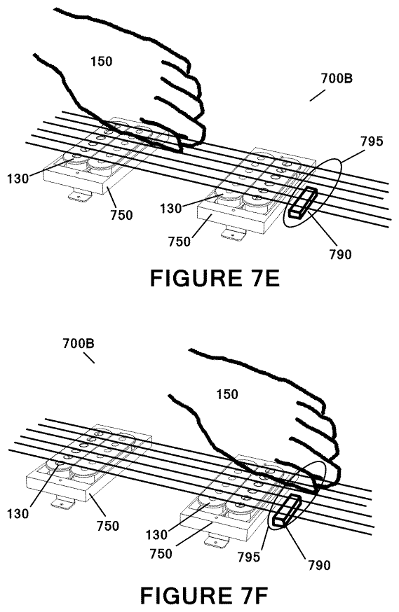

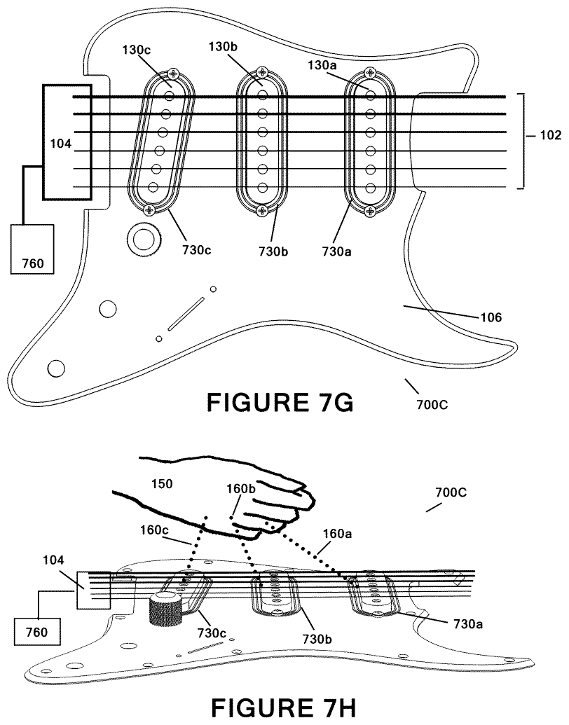

FIG. 7A shows a musical instrument with a pickup position sensor for determining a location of a hand of a musician along a string path. FIG. 7B shows another musical instrument with a pickup position sensor for determining a location of a hand of a musician hand along a string path. FIG. 7A shows musicians hand 150 near instrument pickup 132. Pickup 131 is further from musicians hand 150. In FIG. 7B, musicians hand is closer to pickup 131. Sensors mounted beneath instrument strings 102, combined with sensor processing circuit 120, may determine a musician hand position and send control signals to a pickup selector 135 or audio processor 140.

In this way, sensor output control signals 194 from the pickup sensor system may be used to change musical parameters prior to or while instrument is played. Digital signals from the sensor system may configure audio processor 140 in advance of audio signals, reducing system latency. FIG. 7C shows a pickup position sensor. FIG. 7D shows another pickup position sensor. This configuration features a mounting ring 750 to secure a pickup 130 to the instrument body. Pickup sensors 730d and 730e may detect hand 150 in proximity to pickups 130. FIG. 7C hand 150 increases capacitive coupling area 780 closer to pickup sensor 730d. In FIG. 7D musician hand increases coupling area 780 near pickup sensor 730e.

In an example, areas surrounding or alongside a pickup may be made into touch or proximity sensors. Many instrument designs use a pickguard 106 to mount a pickup 130 to an instrument. An example using this pickguard design is the Fender Stratocaster. FIG. 7G shows a pickguard with pickups and pickup sensors. FIG. 7H shows another pickguard with pickups and pickup sensors.

Optional capacitive coupling signal input 760 may be used with capacitive coupling type of sensor circuits. These sensors connect a sensor signal to instrument strings 102 using conductive bridge 104. Another design uses the chassis of the pickup 130 to secure it directly to the instrument 100 body. In each of these designs we may transform this mounting hardware into a touch or proximity sensor. Conductive metal structures, including mounting screws 820, may be transformed into sensors. Non conductive structures may have conductive materials added to them and transformed into sensors. We may use touch and proximity sensing circuit assembly 185 to determine when a hand is placed in relation to a pickup. Multiple sensors on multiple pickups may be used to determine a hand placement relative to multiple pickups. FIG. 1B and FIG. 1D show examples of pickup and sensor configurations. By analyzing sensor signals from one or multiple pickup sensors 730 the controller 190 may determine a hand position on the instrument. The controller 190 may output a sensor output control signal 194 that may be used to determine which pickup is connected to the audio output 138 of the instrument 100. In this way, a musician may use a playing technique where a hand's location in touch or proximity to a pickup sensor 730 provides selection of the output of a pickup signal 134. A pickup sensor system may be preferred by a musician as a simple and ergonomic way to select between pickups while operating instrument 100. The musician no longer needs to remove the hand from playing position to reach for a manually operated selector control or switch. When using pickup sensors 730, a musician may select an active pickup simply by playing the instrument with a hand touching or in proximity to the desired pickup.

In another example of a pickup hand sensor system, a single sensor may be used to determine two different hand positions. A single sensor may be placed near one pickup, but not near another. Controller 190 may configure a binary threshold status of the sensor which may be used to determine hand position. If hand is near or in touch with a sensor, then the sensor reads true. If a hand is far or not in touch, then the sensor returns false. A single sensor system may provide a controller enough information to determine one hand position and assume the other. In this way the states of two or more pickup signals may be controlled by a single sensor.

For many pickup sensors, a Self Capacitance sensor or a Resonant sensor may successfully detect touch, but have difficulty determining proximity. This may be due to the nearby grounded objects like strings and pickup structures introducing unwanted capacitance. This may also be due to capacitance formed between the conductive sensor and the pickup coil or hardware. In these cases a capacitive coupling signal sensor may be used, (see FIG. 12). Capacitive coupling of high frequency sensor signals may provide proximity detection in areas with competing capacitative fields.

FIG. 7E shows an optical hand position sensor system for detecting a musician's hand position. FIG. 7F shows an optical hand position sensor system for detecting a musician hand position. Optical sensor 709 may include a light source and one or more photo diodes or photo resistors to detect proximity. Light may be reflected off of a musician's hand when it is placed in proximity to the sensor. The reflected light may be detected by the sensor which sends out electrical signals to express the proximity of the hand. FIG. 7E shows hand 150 away from optical sensor 790, and FIG. 7F show hand 150 detected by sensor 790. FIG. 7E and 7F show an example of a single sensor, however multiple sensors may be used.

Proximity may also be determined by ultrasonic, inductive, LIDAR, and other types of emitted waves and fields of radiation. Such sensors may analyze reflections of emitted waves, and measure intensity or time of the reflection to determine proximity.

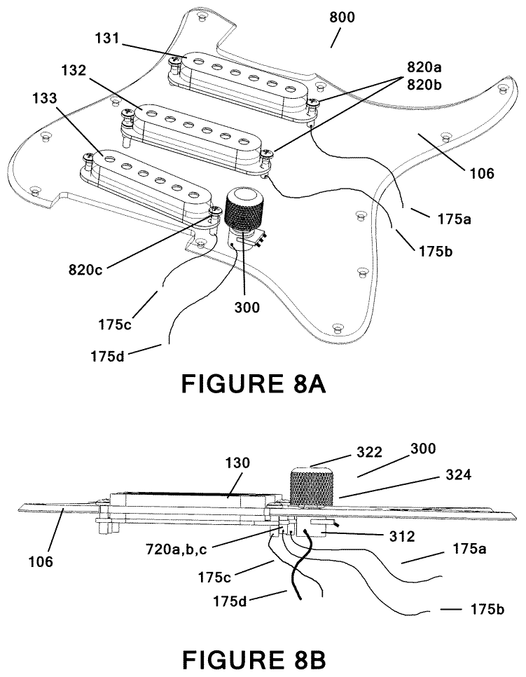

FIG. 8A shows a touch sensitive pickup selection system. The system repurposes typical instrument parts such as screws 820, and a pickguard 106. Instrument pickups 131, 132, 133, which are used to sense instrument strings 102 (not shown) are mounted to pickguard 106 using mounting screws 820. Traditionally, a musician may select between different pickups 131, 132, 133 by using a switch (not shown).

The present disclosure teaches a novel selection system which uses mounting screws 820(a,b,c) for each pickup 131, 132, 133, as touch sensitive surfaces. Each mounting screw 820(a,b,c) is functionally equivalent to sensor surface 170. Sensor wires 175(a,b,c), may connect each mounting screw 820(a,b,c) to a sensor circuit 180. Sensor circuit 180 could be made using self capacitative sensor circuit 1000, or resonant sensor circuit 1100, or signal sensor circuit (see FIG. 12A), or a different touch sensor circuit such as a manufactured IC.

A touch sensitive knob assembly 300 may be mounted into a typical instrument pickguard 710, shown here as transparent and made from a dielectric material. Sensor wire 175d connects the knob assembly to a sensor circuit 180 (not shown). Knob assembly 300 having a coated portion 324 and an uncoated portion 622. Knob assembly 300 may function in conjunction with pickup selection system 800. For example knob 800 touch sensor 322 may be configured to mute audio selected by touch sensitive pickup selection system 800.

FIG. 8B shows a side view of a touch sensitive pickup selection system. Mounting screws 820(a,b,c) are shown attaching the pickguard 106 to pickups 131, 132, 133. Sensor wires 175(a,b,c) attach to mounting screws. Washers may be used to connect wires with mounting screws. Touch sensitive knob assembly 300 is bisected by pickguard 106 between the knob handle and the potentiometer chassis 612. Uncoated sensor surface 622 and coated sensor surface 324 are above the pickguard 106 and accessible to a musician.

FIG. 1D shows a block diagram which may be configured to pickup selection system 800. To select an active pickup, a musician may touch a hand to sensor surface 170(a,b,c). This may be mounting screw 820(a,b,c) or it may be a different surface. A touch event is detected by sensor circuit 180 which is connected via sensor wires 175(a,b,c) and processed by controller 190.

Pickups 131, 132, 133, have audio output signals 134 which are connected by audio signal wires to pickup selector 135. Selector 135 operates via control signals sent from controller 190. Selector 135 may contain relay switches, analog switch ICs, diode switches or similar multiplexing and routing components. The pickup selector 135 may selectively connect pickup audio signals 134 to an instrument output 138.

This system 800 provides for a touch event on a sensor surface 170, such as a pickup mounting screw 820, to connect a pickup audio signal to an instrument output. In another example, different types of hardware may be used as sensor surfaces (170(a,b,c) FIG. 1D) instead of pickup mounting screws 820(a,b,c). In one embodiment pickup mounting rings 750, typically used for humbucking pickups, may be used as sensor surfaces 170(a,b,c). In another embodiment electrodes placed near pickups may be used as sensor surfaces 170(a,b,c).

Instruments may feature many numbers and types of pickups. Pickup selection system 800 may be constructed with any number of pickups or pickup configurations. In one embodiment, a touch event on surface 170 may reverse the phase of a pickup, or it may select multiple pickups, or it may change pickups from parallel to series wiring, or it may remove one coil from a pickup assembly, or it may alter a pickup circuit in a different way. In another embodiment, sensor surfaces 170(a,b,c) may send signals to other devices. These signals may be MIDI type control signals. Or these signals may control lighting or sustaining pickup circuits.

The controller 190 may be configured to use a latching mode where a touch event may toggle an output state. For example, in latching mode, a first touch on a first sensor 170a enables a True state for the corresponding output, and this True state remains after the touch event has ended. A second touch on the same first input 820a toggles a False state for the corresponding output. A False state may also occur after a touch event on a second sensor surface 170b or 170c is true.

Multiple inputs to the controller 190 may be used simultaneously to select multiple outputs. So if 170a and 170b are both true, then their corresponding outputs may both be true. The controller 190 may run other types of programs. For example a sequencing program may cycle through all pickups over a time. A stutter program may rapidly switch a pickup on and off. A volume level or equalization of a pickup may be controlled by the controller in response to a touch event. More than one output 148 may be incorporated into the system and controller 190 may be select between the multiple outputs.

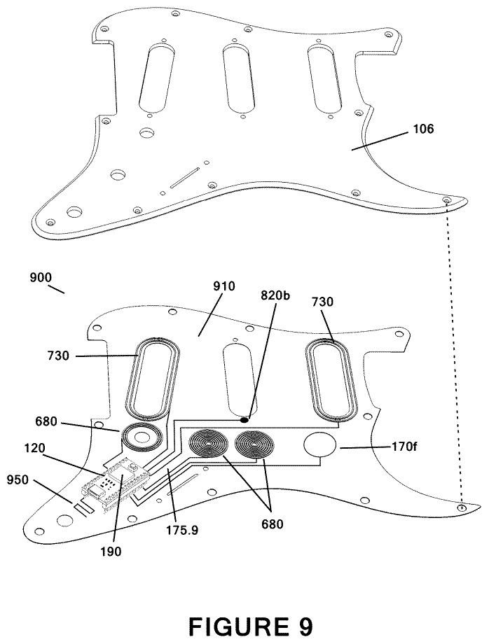

FIG. 9 shows a concealed sensor assembly. This device may be made from a printed circuit board (PCB), or a flexible printed circuit board. This system may also be made as or made to be part of an instrument pickguard 106. A variety of sensor surfaces and types may be arranged on a substrate 910. A substrate may take the shape of an instrument pickguard so that it may be concealed or partially concealed by existing instrument hardware. A plurality of sensor components work together with sensor processing circuit 120. A controller 190 may support multiple sensor circuits 180 and associated sensor surfaces 170. FIG. 9 shows an example of a sensor arrangement. Pickup sensors 730, discrete sensor surfaces 680, receiving sensor surface 170f (where button may be mounted), multiple sensor wires 175.9, and touch sensitive mounting screw 820b, may all be included in a concealed sensor assembly 900. Traditional controls such as pickups, volume and tone potentiometers, and a pickup selecting switch may be mounted through holes in substrate 910. Multiple sensor wires 175.9 are arranged to connect sensor surfaces to sensor processing circuit 120. (FIG. 9, Part 175.9 points to a group of sensor wires which may be PCB traces.) Sensor wires 175.9 and sensor control circuit 120 are pictured on a top surface of substrate 910 for clarity in drawing, however it can be understood that sensor wires and sensor processing circuit may be mounted on the reverse side of a substrate 910. Substrate 910 may be a multi-layer PCB board or a multi-layer flexible PCB board. Controller 190 may send sensor output control signals associated with sensor inputs. Controller may contain or be in communication with a wireless transmitter and antenna 950 which may be a PCB trace. Sensor processing circuit may require more space to fit between an instrument surface and instrument pickguard 106, and so may be positioned on substrate 910 in such a way that components align with cavities in a musical instrument body. In an example concealed sensor assembly 900 is fitted between instrument body and pickguard 106. Pickups 130, volume and tone controls, and selector switch, may be mounted as designed by the instrument manufacturer. A musicians hand may operate instrument 100 in a normal manner with sensor surfaces of the concealed sensor assembly 900 detecting hand location and sending control signals. An audio processor 140 or a touch and proximity sensitive pickup selection system may respond to control signals from controller 190.

FIG. 10A shows a self capacitance sensor circuit of a musical instrument, located between sensor pin 192 and sensor wire 175. The sensor circuit 1000 may be part of a self capacitance type sensor apparatus. The circuit is designed to provide smooth and accurate sensor system readings while protecting the sensor pin 192 from harmful voltage or current. The sensor circuit 1000 may also prevent some electro magnetic frequencies from being transmitted by a sensor surface 170.

FIG. 10B shows a controller with a sensor pin connected to a sensor circuit. Self capacitance sensor circuit 1000 is a type of sensor circuit 180 in FIG. 1A. Sensor wire 175 connects the sensor circuit 1000 to the sensor surface 170. A hand 150 may add capacitance 160 to the sensor circuit.

Controller 190 first measures total capacitance of untouched surface 170 along with sensor circuit 1000, by measuring the time it takes to charge to a threshold voltage. Controller 190 configuration thresholds may be adjusted according to this first capacitance measurement. After a charge threshold is reached or a time has passed, the controller 190 may set pin 192 LOW to ground 1020, discharging the capacitor 1004. Capacitor 1004 is charged by controller pin 192. The time it takes to charge capacitor 1004 is then recorded by the controller 190. Multiple readings may be taken by controller 190 and a comparison of charge times can be made. When controller 190 measures a longer charge time due to a greater capacitance of hand 150 touching sensor surface 170, a proximity or touch event is determined.

A human hand may provide capacitance 160 and resistance 165 when touching the sensor surface 170. A human hand may or may not be connected to system ground 1020. A musicians hand is typically connected to ground through instrument strings. However there are times when a musicians hand may not be connected to ground. Thresholds may be set to detect touch and proximity of a musicians hand in either state.

Capacitor 1004 and capacitance 160 are in series and are charged simultaneously. Resistor 1012 connects the sensor surface 170 to ground 1020 through sensor wire 175. This pulls the sensor surface 170 low immediately after capacitors 1004 and capacitance 160 are charged. Capacitor 1004 and resistor 1012 may form part of a high pass RC filter. Low frequency signals that may be generated by external EMF, mains power, ESD, or other transients may be filtered by the high pass filter.

Self capacitive sensor circuit 1000 may be enhanced by additional components. Circuit protector 1018 may direct ESD events toward ground 1020 before they are able to damage controller pin 192. Circuit protector 1018 may be a diode, a TVS diode, a varistor, or other types of circuit protection. Resistor 1014 may be added to extend the charge time of capacitor 1004. Capacitor 1016 may be added to tune the capacitance of the system. Resistor 1014 and capacitor 1016 together form a low pass filter which may be used to smooth sensor readings and protect the pin 192 from damaging high voltage transients.

Sensor system 1000 may be designed for use in sensitive audio environments, such as where external signals under 20 kHz are unwanted. The sensor system may feature noise rejection techniques through the use of electronic circuitry and/or firmware executing on controller 190 or other programmable electronic device. External noise rejection may be important to ensure accurate sensor measurements. Noise rejection may be important to keep noise generated by the sensor and the external environment from coupling to an instrument's audio output.

Static charge accumulated on a human body may discharge into a sensor surface when touched. The static charge may cause transient voltages on the sensor surface thus creating audible noise and sensor noise, such as noise caused by an EMF. Electronic stringed instruments with electromagnetic pickups may be sensitive to noise coupling from very small EMFs. For example, a noise signal from an electric guitar with magnetic pickups may be amplified. Saturation of the signal, distortion, compression, and gain, may amplify add to the creation detection of transient noise. The present disclosure may provide a touch sensor for electronic instruments that filters transient noise while maintaining the sensitivity of the sensor.

Controller 190 may measure the charge time of the capacitance of a sensor surface attached to the instrument. The capacitive sensor may include one or more capacitors in series with the capacitance of the sensor surface being measured. Multiple capacitors arranged in series may reduce the total capacitance. By limiting the maximum size of the equivalent total capacitance in the circuit, we may limit the maximum time that may be measured by a the controller to charge the equivalent total capacitance. A smaller capacitance may reach a threshold voltage faster than a larger capacitance, given the same resistance. The range of human hearing is generally understood to be typically below 20 kHz. So we may choose a capacitor to place in series with the capacitive surface such that the capacitor is small enough to keep the charging frequency above 20 kHz. As such, a human may not be able to hear the frequencies generated when the capacitive sensor is charged.

For example, if self capacitive sensor circuit 1000 places a 100 pF capacitor (1004) between the controller 190 and the capacitive sensor surface 170, and there is a 33K ohm resistor 1012 connected to ground, then a highpass filter with a cutoff frequency of about 48.25 kHz may be created. This filter may aid in reducing audible noise generated by the controller 190, other circuits, or external sources, from passing through to the sensor surface 170. This may be important when the sensor surface 170 is near the instrument pickups 130, as these frequencies may be reduced in the instruments audio output. An added benefit of the resistor may be that ESD (Electro Static Discharge), from an external object or human, may have a path to ground. Damaging voltage of the ESD may be diverted away from the electronic controller. The addition of the first capacitor in series with the second capacitance of the conductive surface of the sensor may allow the electronic controller to charge a value less than the first capacitor. In an example, when the touched object is measured at 100 pF, then the series capacitance of the 100 pF capacitor and the 100 pF touched object, may total 50 pF. Depending on the resistance of the circuit and percent of charge the electronic controller considers sufficient, this may yield a charge time in the microsecond range. A pullup resistor of 33K inside the controller, may charge a total capacitance of 50 pF in about 1.6 uS, which would be a frequency of 625 kHz. Through this design we may keep the sensor noise out of the audible range of frequencies.

Other types of filters may be used to create a filter for a capacitive touch sensor. A second order high pass filter may be created by placing two RC high pass filters in series. A lowpass filter may be useful for eliminating mains EMF and ESD noise. Inductors and ferrite beads may be added, preferably to the sensor wire, to filter high frequency noise.

FIG. 10B shows self capacitive sensor circuit 1000 serving as sensor circuit 180 as part of a sensor processing circuit 120. Self capacitive sensor circuit 1000 connects to controller I/O pin 192. Sensor wire 175 connects sensor circuit 1000 with sensor surface 170. Sensor surfaces may include a whammy bar, a vibrato system, a pickup hardware, a knob, a button, a truss rod, a screw or other hardware, a sensor matrix, or other sensor surfaced described herein.

FIG. 11 shows a resonant circuit as a type of sensor circuit. A controller 190 is connected to a resonant circuit 1116, which is made with at least capacitor 1104 and inductor coil 1106. These components are connected in parallel forming a resonant LC tank circuit. Controller 190 may charge capacitor 1104 using a charging pin 1102. When sufficiently charged, controller 1102 may ground or disconnect the charging pin 1102. A charge will resonate between capacitor 1104 and inductor 1106, the frequency of which may be measured by the controller using either frequency measurement pin 1108 or by reassigning pin 1102.

Sensor wire 175 may connect the resonant LC tank 1116 to a sensor surface 410. In one embodiment sensor surface 1110 is the same as sensor surface 170 used in FIG. 1b. In another embodiment sensor surface 1110 may be part of inductor coil 1106. Sensor surface 1110 may have a capacitance 160 that may be added to the capacitance of the resonant tank 1116. The frequency of the resonance of LC tank 1116 may be determined by the total capacitance of capacitor 1104 and capacitance 160, along with the inductance and resistance of inductor 1106.

The capacitance of hand 150 in proximity to sensor surface 1110 may cause capacitance 160 to rise. This additional capacitance, when added to the resonant tank capacitance, may lower the resonant frequency of the tank circuit. A distance 1114 along with the surface area of the sensor surface 1110, and surface area of hand 150, may determine the amount of change to capacitance 160.

A proximity or touch event may be determined by a controller 190 after a change in frequency has been detected on frequency measurement pin 1108. Multiple thresholds of sensed frequencies may be configured by controller 190 to output corresponding control signals.

Resonant sensing circuit 1100 may be preferable for proximity and touch detection. LC tank circuit 1116 may also function as a band pass filter. This filter may reject both high and low frequency noise which may be introduced by hand 150 touching sensor surface 1110. This noise filter is particularly useful when there is a need to detect high resolution measurements of the proximity of hand 150 position.

In an example, a touch sensor may include a resonant circuit, such as a tank circuit. A resonant circuit may include an inductor and a capacitor which may be tuned to a resonant frequency. The resonant frequency may be determined by the total capacitance, inductance, and resistance of the components. By modulating the capacitance of the resonant circuit, the resonant frequency of the resonant circuit may be changed. When touched, the capacitance of the human body may alter the total capacitance of the circuit and thereby the resonant frequency of resonant circuit. By adding a conductive touch surface to the capacitor of the resonant circuit, a variable capacitor may be created by combining the internal capacitor of the resonant circuit with the external capacitance of the conductive surface. This surface may be touched or nearly touched (proximity) by a musician to change the frequency of the resonant circuit.

An electronic controller or similar logic or analog circuit may be used to monitor the resonant frequency and determine when a circuit is untouched, touched, or nearly touched, and sense a range of variables in between often called proximity sensing. The output of this sensor data may be used as a control for musical expression.

Resonant frequency sensing may be advantageous in electrically noisy environments. The inductor and capacitor of the resonant circuit may form a band-pass filter which may suppress unwanted electrical noise. Low frequency 50 and 60 cycle hum may be rejected, as well as high frequency noise from switching power supplies, data signals, and other external devices. Proximity sensing may require the ability to detect very small changes of capacitance (e.g., pico and femtofarad ranges) in the resonant circuit to determine a near touch variable. Filtering external noise from the sensor may improve the accuracy and consistency of measurements.

A resistive touch sensor may be created using the human body's resistive component 165. In this type of sensor, a voltage may be supplied to conductive sensor surface 170 (e.g., 3.3 v). A voltage divider may be created using the body's resistance 165 and the sensor circuit 180 resistance where sensor processing circuit 120 may measure the voltage divided between the them. For example, the strings of a guitar are typically grounded. When the musician hands are placed on both the strings and the touch sensor, a voltage divider may be created between the supply voltage and ground, where the electronic controller may measure the difference. The electronic controller may then output a binary or a variable control data.

FIG. 12A shows a functional block diagram of a capacitive coupling signal sensor. A capacitive coupling touch and proximity sensor may detect a musician hand position while playing musical instrument 100. A transmitter signal 1234 connects to a transmitter surface (Tx) 1232. A receiver surface (Rx) may be capacitively coupled to the transmitter Tx surface. Signals generated on the Tx surface 1232 may produce a corresponding signal on the Rx surface. Multiple receiver Rx surfaces 170a and 170b may couple to the same Tx surface. The surface area and distance of Tx and Rx sensor surfaces may influence the amount of capacitance formed between them. Transmitter signal 1234 may be generated by controller 190 or another type of oscillator circuit. A musicians hand placed near the Tx or the Rx sensor surface may increase the capacitance of the sensor. The added surface area of a musicians hand placed in proximity to the sensor surfaces may increase the amount of capacitive coupling between the Tx and Rx components. The amplitude of a signal that travels from the Tx circuit to the Rx circuit may change due to the additional capacitance 161 of a hand. This change in signal amplitude may be sensed by sensor processing circuit 120 which is configured to measure the amplitude of signals received on Rx surfaces. Corresponding control signals may be sent by controller 190 to other circuits. Other circuits may include pickup selector 135, auxiliary circuits 199, and output control signals 194 may be sent to audio processor 140.

In an example, FIG. 12A shows a capacitive coupling signal sensor 1200 with a Tx surface 1232 and two Rx surfaces 170a and 170b. A transmitter signal 1234 is generated by controller 190, and may be an inaudible signal above 20 kHz. Tx signal 1234 is connected to instrument strings 102 which serve as a transmitter surface 1232. Receiver Rx surfaces 170a and 170b may be pickup position sensors 700 (as shown in FIG. 7A through 7D) or they may be other types of sensor surfaces 170. When musicians hand 150 is placed near instrument strings 102, additional capacitance 161 may change the amplitude of signals coupled between Tx and Rx surfaces. Controller 190 may measure signal amplitude on an Rx surface and determine if a hand is placed in proximity to the sensor surface. In this example controller 190 may compare the amplitude of two signals received by two Rx surfaces 170a and 170b, and determine which is larger. Controller may send control signals to pickup selector 135 which may connect a pickup audio to an instrument output corresponding with the position of musicians hand 150. In this example, musician may also control audio processor 140 using sensor output control signals 194. For example, audio processor 140 may increase gain and reverb of the processed audio signal 143 when musicians hand is placed near sensor surface 170b.

A Tx or Rx sensor surface may be constructed with a coiled wire or a coil PCB trace. The coil may be placed near or around an instrument pickup. FIG. 7C and 7D show pickup sensors 730d and 730e as a coil part of mounting ring 750. FIG. 7G and 7H show pickup sensors 730a 730b and 730c as part of a pickguard 106. The coil may have resonant frequencies determined by the wire geometry, capacitance, and inductance. A hand placed in proximity to the coil may increase the capacitance of the coil. An increase in capacitance may change the resonant frequency of the coil circuit. If the Tx signal 1234 frequency is similar to the coil resonant frequencies, the amplitude of the detected signal may be greater than at non resonant frequencies. A musicians hand 150 may provide additional capacitance 161 to a coil type sensor surface 170 which may change the resonant frequency of the coil. So amplitude of the signal received on the Rx sensor coil surface may increase or decrease as the resonant frequency of the coil changes. Controller 190 may measure these changes in amplitude. Capacitors or other components may be added to the sensor coil to tune it's resonant frequency. Filters may also be used to condition the signal. For example a high pass filter is useful to remove audible frequencies and external EMFs from the sensor circuit 180a and 180b.

In another example, signals from external sources such as mains power (typically 50 or 60 Hz), or a voltage boost converter circuit, may be connected to the Tx surface 1232. In this case, no signal generator is required because external signals are already present. Capacitive coupling signal sensors are well suited to determine touch and proximity of a hand while placed near instrument pickups. Pickups may impart a large parasitic capacitance in the sensor area, which may cause other types of capacitive sensors perform poorly.

Capacitive coupling touch and proximity sensor 1250 may be useful for determining touch and proximity of a hand in other areas of the instrument, for example on other types of touch sensitive controls. A musician may hold strings with one hand and operate a touch or proximity control with the other hand. Signals may couple through the musicians body to the sensor surfaces. For example, a sensor receiver may be placed on or in the neck of an instrument to determine the position of the hand on the neck, as shown in FIG. 5B and 5C. A sensor Rx receiver may be placed on the body of an instrument to create a touch or proximity sense of that body region, as shown in FIG. 6A and 6C. A sensor receiver may be placed near or made to be part of a knob or switch or button to determine proximity or touch of that control, as shown in FIG. 3B and 4B. A signal sensor receiver may be part of a touch sensitive whammy bar sensor circuit, as shown in FIG. 2A, 2B and 2F. A musicians hand position and proximity can be sensed at these receiver sensor locations when capacitive coupling of the hand with the sensor receiver changes amplitude of the signal received by the sensor circuit.

Reverse function: In another embodiment of capacitive coupling signal sensor, multiple signal transmitters Tx are placed at various locations on an instrument. Each Tx may be transmitting a different frequency. At least one receiver may detect which frequency is being received. The receiver circuit may determine a touch or proximity event at the location of the transmitter which correlates to the frequency received.

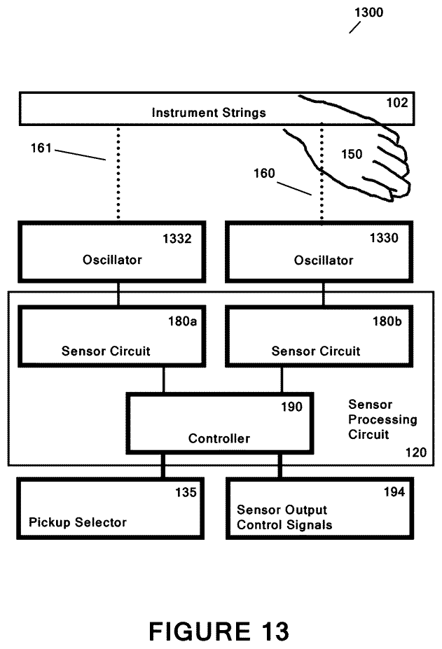

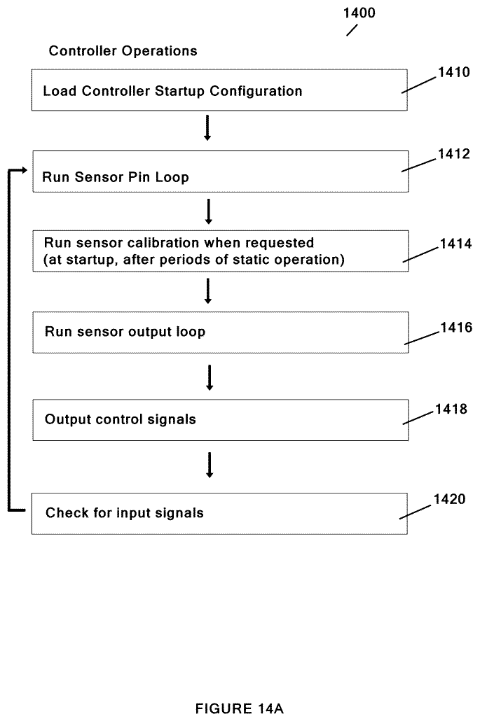

FIG. 13 shows an oscillator sensing circuit.

An oscillator may include a capacitor as part of the oscillator circuit. This sensor may use an oscillator that is capacitively coupled to a musicians hand. When a musicians hand is coupled with the capacitor, the frequency of the oscillator may change. This change may be measured by a sensor processing circuit 120. Oscillator sensor circuit 1300 may combine the internal capacitance of an oscillator circuit with an added capacitance of a musicians hand 150. As hand 150 approaches in proximity with oscillator circuit capacitance sensor 1330, the combined capacitance may lower an oscillation frequency. Controller 190 may measure frequency of oscillation and determine the position of hand 150.

An example of this sensor uses two oscillators which may be tuned so their frequencies, when combined, produce an interference frequency, known as a heterodyne. A first oscillator 1332 is fixed and a second oscillator 1330 may be tuned by capacitive coupling of a musicians hand. By connecting one oscillator to a conductive instrument hardware, for example a whammy bar, for another example a truss rod, we may use the added capacitance of that hardware, plus the capacitance and resistance of the musicians hand, to tune the oscillator. The resulting heterodyne frequency may be read by a controller as a sensor circuit output. An oscillator circuit may be preferable because it allows the use of very high frequency oscillators while a lower frequency sensor signal is detected by the controller.

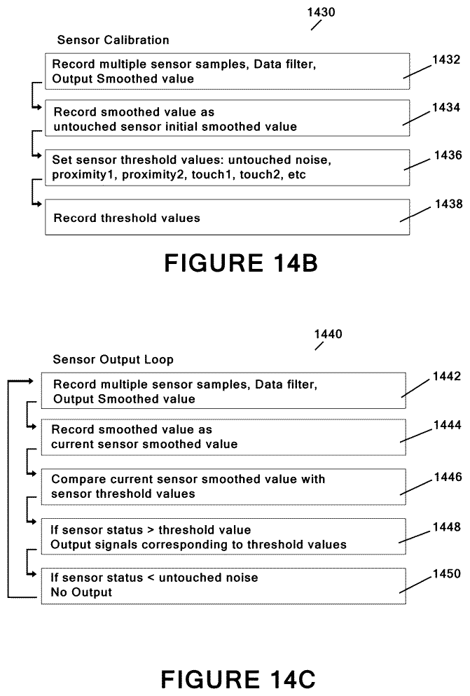

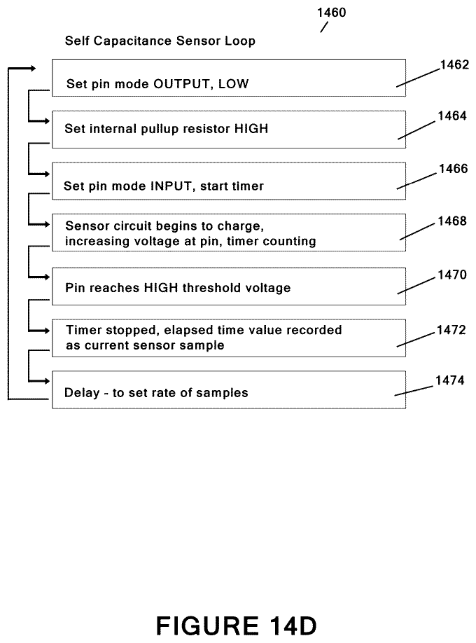

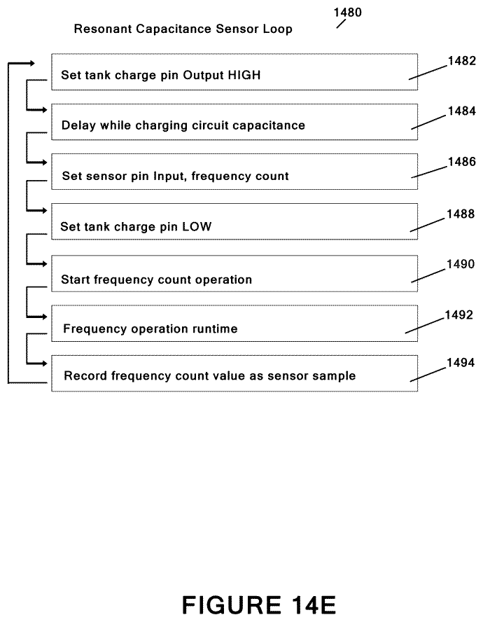

FIG. 14A shows a flowchart of controller operation. At startup, controller 190 may load controller startup configuration 1410. Startup configuration may include controller input and output configurations, processor speed, and communication protocols. Sensor pin loop 1412 is started to determine the status of sensor inputs. Sensor pin loop 1412 may be of may types depending on the type of sensor circuit 180 used for each input. FIGS. 14D and 14E show two examples of sensor pin loops 1412. Sensor surfaces are calibrated 1414 with untouched measurements. Threshold values for untouched noise, a range of proximity, and a range of touch are calculated. Sensor output loop 1416 measures sensors and determines output actions. Output control signals 1418 are sent respecting protocol system timing. The controller may be available for loop interruptions and other input signals 1420 from sensors and other data processes. FIG. 14B shows a flowchart of sensor calibration 1430. Sensor samples are output from sensor pin loops. These samples may be filtered and averaged or smoothed 1432. The smoothed value is recorded 1434. Calibration threshold values may be calculated 1436. And these values are recorded 1438 for comparison with future sensor inputs.

FIG. 14C shows a flowchart of sensor run loop 1440. Multiple samples may be smoothed 1442. Current sensor status is updated 1444. Controller 190 may compare current sensor status with recorded threshold values 1446. Logic may determine corresponding output signals 1448 and No Output signal 1450.

FIG. 14D shows a flowchart of self capacitance sensor loop 1460. Pin mode is output LOW 1462, to give a clean start for the sensor charge. Sensor circuit 1000 is charged with a voltage through internal or external switching 1464. Charge time will be calculated by controller so we set pin to input and begin timer 1466, after switching voltage HIGH. Timer runs as capacitance charges sensor circuit 1468. When a threshold value is reached 1470, timer is stopped and value recorded 1472. A delay may be added to influence the sample rate and provide resources for other system operations.

FIG. 14E shows a flowchart of a resonant sensor loop 1480. Resonant LC tank is charged 1482 using a charge pin. We may wait a slight delay while circuit is charging 1484. Sensor pin is set to input and configured to count frequency of a resonance 1486. Charge pin may be disconnected or set low as to minimally interfere with resonance 1488.

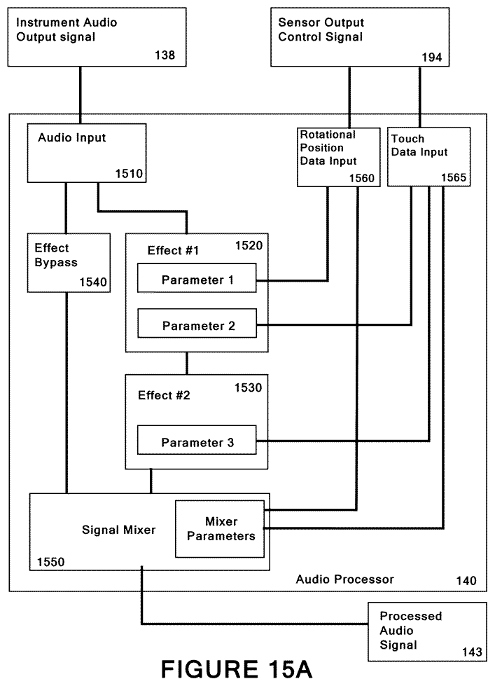

Start measurement operation 1490. As tank is resonating we count the frequencies using input sensor pin 1492. Frequency value may be number of peaks or crossings per fixed unit of time, or it might be a timer set to record the time of a certain fixed number of peaks or crossings. Results are recorded as a sample value 1494. FIG. 15A shows an audio processor. In this example, audio processor 140 is a Digital Signal processor (DSP) which may be used to process an instrument audio signal. Audio processor 140 is typically used by a musician to modulate an instrument audio output signal 138 which is connected to audio input 1510. Sensor output control signals 194 from controller 190 may be used to configure audio processor 140 and manipulate parameters of effects 1520 and 1530. The sensor output control signals may be separated by signal type to control different parameters. Rotational position data input 1560 and Touch data input 1565 may be configured to control different effects and parameters. For example a whammy bar rotational position may control a pitch shift frequency and whammy bar touch sensor may change frequency octave. DSP effects may impart a delay referred to as latency on a signal. A signal may be converted from an analog audio signal to a digital audio signal, processed, and converted back to an analog audio signal. This process may impart latency. Pitch detection and pitch shifting algorithms may increase latency of an audio signal. A touch sensitive electric vibrato system may be used to activate or bypass all or a portion of a signal processor, as part of a signal chain. A vibrato system touch sensor, in an untouched state, may be configured to bypass an algorithm or processor. A vibrato system touch sensor, in a touched state, may be configured to activate an algorithm or processor. A pitch shifting algorithm may be one of the types of processing activated or bypassed by the touched or untouched state of the vibrato system's touch sensor. In this way, a musician may play through a low latency signal path, using a bypassed pitch shifting algorithm, when not touching a vibrato system. And a musician may play though a higher latency signal path, while using an active pitch shifting algorithm, when touching a vibrato system. In an example, a controller of a touch sensitive electronic vibrato system may send multiple control signals to an audio processor 140. A first control signal may indicate touch sensor status and sent to touch data input 1565. Status may include touched, untouched, or a range of proximity. A second signal may be sent to indicate that a whammy bar has begun rotational movement. Rotational position data input 1560 receives data and routes to signal mixer 1550. Signal mixer 1550 determines that musician is using whammy bar and activates effect #1 signal path. This may remove the instrument audio signal from effect bypass 1540 signal path. Rotational position data is sent to effect #1 (1520) to modulate pitch shift frequency. When musician activates touch sensor of whammy bar while using effect #1 (1520), a second parameter 2 may change pitch octave based on touch data input 1565. In this way, an electronic vibrato system may activate a processor or algorithm when it is being used in a non resting rotational state. Latency may be avoided when vibrato system is unused in a resting state. Control of multiple effects is possible, for example touch data input 1565 may be also connected to effect #2 1530 parameter 3. In another example, a musician may control whammy bar touch sensor without rotating the whammy bar. Touch data input 1565 may be connected to signal mixer 1550 which changes audio input 1510 from bypass 1540 to effect chain including Effect #1 (1520) and Effect #2 (1530). Audio processor 140 may account for phase differences between signals when switching between bypassed and latency signal paths.

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention. Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting aspects and embodiments of the invention are intended to encompass both structural and functional equivalents thereof. It is intended that such equivalents include both currently known equivalents and equivalents developed in the future.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments and aspects that are shown and described herein. Rather, the scope and spirit of the invention is embodied by the appended claims.

What is claimed is:

1. A stringed instrument, comprising:
a pickup circuit including a pickup disposed proximate a string of the stringed instrument and configured to produce an audio signal of the stringed instrument in response to a movement of the string;
a sensor circuit electrically distinct from the pickup circuit and the string and including a cantilevered musical expression lever having an insulated section and a conductive section composing a capacitive touch sensor and a sensor processing circuit in electronic communication with the capacitive touch sensor configured to produce a data signal based on a state of the capacitive touch sensor.

2. The stringed instrument of claim 1, wherein the cantilevered musical expression lever is mechanically connected to a body of the stringed instrument via at least one or more of a spring, a bearing, or a bushing and the capacitive touch sensor is in electronic communication with the sensor processing circuit via the one or more of the spring, the bearing, or the bushing.

3. The stringed instrument of claim 1, wherein the insulated section comprises a dielectric material.

4. A stringed instrument, comprising:
a pickup circuit including a pickup disposed proximate a string of the stringed instrument and configured to produce an audio signal of the stringed instrument in response to a movement of the string; and
a sensor circuit electrically distinct from the pickup circuit and the string and including a capacitive sensor and a sensor processing circuit in electronic communication with the capacitive sensor configured to produce a data signal based on a state of the capacitive sensor.

5. The stringed instrument of claim 4, wherein the pickup circuit is configured to produce the audio signal to an audio output of the stringed instrument and the sensor processing circuit is configured to produce the data signal to a data output of the stringed instrument.

6. The stringed instrument of claim 4, further comprising a processor configured to process the audio signal and the data signal to yield a combination output signal of the stringed instrument, wherein the pickup circuit is configured to produce the audio signal to the processor and the sensor processing circuit is configured to produce the data signal to the processor.

7. The stringed instrument of claim 4, wherein the capacitive sensor comprises a capacitive touch sensor.

8. The stringed instrument of claim 4, further comprising a cantilevered musical expression lever comprising the capacitive sensor.

9. The stringed instrument of claim 8, wherein the cantilevered musical expression lever comprises an insulated section and a conductive section composing the capacitive sensor.

10. The stringed instrument of claim 9, wherein the insulated section comprises a dielectric material.

11. The stringed instrument of claim 8, wherein the cantilevered musical expression lever is mechanically connected to a body of the stringed instrument via at least one or more of a spring, a bearing, or a bushing and the capacitive sensor is in electronic communication with the sensor processing circuit via the one or more of the spring, the bearing, or the bushing.

12. The stringed instrument of claim 8, wherein the sensor circuit comprises the cantilevered musical expression lever.

13. The stringed instrument of claim 4, wherein the sensor processing circuit is configured to determine the state of the capacitive sensor by measuring a change in charge time between an untouched state and a touched state of the capacitive sensor.

14. The stringed instrument of claim 4, wherein the sensor processing circuit is configured to determine the state of the capacitive sensor by measuring a change in resonance frequency between a capacitive circuit and an inductive circuit in response to an untouched state or a touched state of the capacitive sensor.

15. The stringed instrument of claim 4, wherein the capacitive sensor comprises a capacitive proximity sensor.

16. The stringed instrument of claim 15, wherein the sensor processing circuit is configured to determine the state of the capacitive proximity sensor by measuring a change in oscillator frequency in response to a proximity of a player's hand to the capacitive proximity sensor.

17. The stringed instrument of claim 15, wherein the pickup circuit further comprises an alternate pickup, the capacitive proximity sensor is disposed proximate at least one of the pickup and the alternate pickup, and the state corresponds to which of the pickup and the alternate pickup a user's fingertips are closest.

18. The stringed instrument of claim 4, wherein the capacitive sensor comprises a screw, an inlay, a button, a knob, a bridge, a pick guard, or a switch.

19. A method, comprising:
providing a stringed instrument, comprising:
a pickup circuit including a pickup disposed proximate a string of the stringed instrument and configured to produce an audio signal of the stringed instrument in response to a movement of the string;
a sensor circuit electrically distinct from the pickup circuit and the string and including a capacitive sensor and a sensor processing circuit in electronic communication with the capacitive sensor configured to produce a data signal based on a state of the capacitive sensor;
producing, by the pickup circuit, the audio signal to an audio output of the stringed instrument;
receiving, at the sensor processing circuit, the state of the capacitive sensor; and producing, by the sensor processing circuit, the data signal to a data output of the stringed instrument based on the state of the capacitive sensor.

20. The method of claim 19, further comprising modulating, by an audio processor, one or more of an amplitude or pitch of the audio signal based on the data output.

21. A device, comprising:
a sensor circuit configured for installation in a stringed instrument such that the sensor circuit is electrically distinct from a pickup circuit of the stringed instrument, the pickup circuit including a pickup disposed proximate a string of the stringed instrument and configured to produce an audio signal of the stringed instrument in response to a movement of the string, and the string, the sensor circuit including a capacitive sensor and a sensor processing circuit in electronic communication with the capacitive sensor configured to produce a data signal based on a state of the capacitive sensor.

22. The device of claim 21, wherein the capacitive sensor comprises a capacitive touch sensor.

23. The device of claim 21, further comprising a cantilevered musical expression lever comprising the capacitive sensor.

24. The stringed instrument of claim 23, wherein the cantilevered musical expression lever comprises an insulated section and a conductive section composing the capacitive sensor.
